(19) United States
(12) Patent Application Publication
(10) Pub. No.: US 2023/0095577 A1
(43) Pub. Date: Mar. 30, 2023

(54) MICROSCOPE DEVICE, IMAGE ACQUISITION SYSTEM, AND IMAGE ACQUISITION METHOD

(71) Applicant: SONY GROUP CORPORATION, TOKYO (JP)

(72) Inventors: HIROKAZU TATSUTA, TOKYO (JP); TOMOHIKO NAKAMURA, TOKYO (JP); SHINJI WATANABE, TOKYO (JP); KENJI YAMANE, TOKYO (JP); YOSHIO SOMA, TOKYO (JP)

(21) Appl. No.: 17/905,189

(22) PCT Filed: Feb. 15, 2021
(86) PCT No.: PCT/JP2021/005418

§ 371 Date: Aug. 29, 2022

(30) Foreign Application Priority Data
Mar. 5, 2020 (JP) 2020-037742

(51) Int. Cl. G06V 20/69; G01N 21/64; H04N 23/69; H04N 23/61; G06V 10/25; G06V 10/44

(52) U.S. Cl. CPC G06V 20/695; G01N 21/6458; H04N 23/69; H04N 23/61; G06V 10/25; G06V 20/693; G06V 10/44

(57) ABSTRACT

To provide a microscope device capable of efficiently or appropriately acquiring an image of a specific region of a living tissue.

The present technology provides a microscope device including: a first imaging element that images a target including a body tissue and acquires image data; and a second imaging element that images the target at a magnification different from a magnification of the first imaging element and acquires image data, in which the first imaging element includes a determination unit that determines a feature related to the target on the basis of the image data, and the second imaging element is controlled on the basis of a result of the determination. Furthermore, the present technology also provides an image acquisition system including the microscope device. Furthermore, the present technology also provides an image acquisition method performed in the microscope device.

### TECHNICAL FIELD

The present technology relates to a microscope device, an image acquisition system, and an image acquisition method. In more detail, the present technology relates to a microscope device that images a living tissue, an image acquisition system including the microscope device, and an image acquisition method for a living tissue.

### BACKGROUND ART

For pathological diagnosis, a living tissue image obtained by a microscope device can be used. In recent years, a digital image of a living tissue is acquired, and pathological diagnosis can be performed on the basis of the digital image. Several technologies related to acquisition of the digital image have been proposed so far.

For example, Patent Document 1 below discloses an information processing device including: an image analysis unit that divides an entire image obtained by imaging an entire observation target region into a plurality of regions and determines whether or not an observation target exists for each region; and an imaging control unit that controls imaging of a partial image having a higher magnification than that of the entire image corresponding to the region on the basis of a determination result of the image analysis unit, in which after imaging a first partial image corresponding to a region adjacent to a region in which there is a possibility that the observation target exists and there is a possibility that the observation target exists, the imaging control unit controls imaging so as to image a second partial image corresponding to a region adjacent to a region in which there is a possibility that the observation target exists and the observation target does not exist.

### CITATION LIST

### Patent Document

Patent Document 1: WO 2013/179723 A

### SUMMARY OF THE INVENTION

### Problems to be Solved by the Invention

In order to perform pathological diagnosis, a digital image of a living tissue can be used, and the digital image can be acquired using, for example, a microscope device. In the acquisition of the digital image using the microscope device, for example, an entire image of a target can be acquired first, and next, a partial image can be acquired for a region of interest in the entire image. As described in Patent Document 1 described above, the entire image can be used to control imaging of the partial image.

When the partial image acquisition processing as described above can be performed more efficiently or more appropriately, it is considered to contribute to improvement of convenience for the user or provision of useful information to the user. Therefore, a main object of the present technology is to provide a technology for more efficiently or more appropriately acquiring a partial image.

### Solutions to Problems

The present technology provides a microscope device including:

a first imaging element that images a target including a living tissue and acquires image data; and

a second imaging element that images the target at a magnification different from a magnification of the first imaging element and acquires image data, in which

the first imaging element includes a determination unit that determines a feature related to the target on the basis of the image data, and

the second imaging element is controlled on the basis of a result of the determination.

The second imaging element can divide the imaged region into a plurality of regions, image at least one of the plurality of regions, and acquire image data.

The first imaging element may be configured as an imaging element in which the determination unit and an imaging section that performs imaging are arranged in a single chip.

The second imaging element can image each of the plurality of regions at a higher magnification than the first imaging element.

The image data can include bright-field image data and/or fluorescence image data.

The image data can include an image signal including a luminance value and/or a frequency.

The feature related to the target can include a feature related to an attribute of the target.

The feature related to the attribute of the target can include one or more selected from a feature related to an attribute of the living tissue, a feature related to an autofluorescence component, and a feature related to a lesion in the living tissue.

The feature related to the target can include a feature related to a region of the target.

The feature related to the region of the target can include one or more selected from a feature related to a lesion region in the living tissue and a feature related to a foreign substance in the target.

The determination unit can perform the determination using a learned model.

The microscope device may further include a control unit that performs imaging control of the target by the second imaging element or control of processing of an image obtained by the second imaging element, on the basis of a result of determination by the determination unit.

The control unit can further include an imaging sequence control unit that controls an imaging order on the basis of the feature related to the region of the target.

The imaging sequence control unit

may perform imaging control such that a joint of a plurality of regions does not overlap a region of interest in the target or

can perform imaging control such that the region of interest in the target is imaged a plurality of times.

The control unit can further include an exposure control unit that controls a gain and/or an exposure time.

The exposure control unit can control the gain and/or the exposure time in units of pixels and/or in units of wavelengths.

The control unit can further include a light amount control unit that controls a light amount of a light source.

Processing of the image can include fluorescence separation processing.

Furthermore, the present technology provides an image acquisition system including:

a microscope device including a first imaging element that images a target including a living tissue and acquires image data, and a second imaging element that images the target at a magnification different from a magnification of the first imaging element and acquires image data, the first imaging element further including a determination unit that determines a feature related to the target on the basis of the image data, the second imaging element being controlled on the basis of a result of the determination; and

a control unit that performs imaging control of the target by the second imaging element or control of processing of an image obtained by the second imaging element on the basis of a result of the determination.

Furthermore, the present technology also provides an image acquisition method including:

a first imaging process of imaging a target including a living tissue and acquiring image data by a first imaging element;

a determination process of determining a feature related to the target based on the image data, performed by a determination unit included in the first imaging element; and

an imaging, second imaging process of imaging the target at a magnification different from a magnification of the first imaging element and acquiring image data, in which

the second imaging element is controlled on the basis of a result of the determination.

### BRIEF DESCRIPTION OF DRAWINGS

FIG. 1A is a schematic diagram for describing a configuration example of a microscope device according to the present technology.

FIG. 1B is a schematic diagram for describing a configuration example of a microscope device according to the present technology.

FIG. 2 is a schematic diagram illustrating a configuration example of a first imaging element.

FIG. 3 is a perspective diagram illustrating an outline of an external configuration example of the first imaging element.

FIG. 4 is a diagram illustrating a configuration example of an image acquisition device that performs imaging by a line-scan method.

FIG. 5 is a diagram illustrating a configuration example of an optical system of an image acquisition device that performs imaging by a line-scan method.

FIG. 6 is a diagram for describing an example of an imaging target.

FIG. 7 is an enlarged diagram of a part of an imaging target for describing an illumination area and an imaging area.

FIG. 8 is a diagram describing a spectral data acquisition method in a case where the imaging element includes a single image sensor.

FIG. 9 is a diagram illustrating wavelength characteristics of spectral data acquired in FIG. 8.

FIG. 10 is a diagram describing a spectral data acquisition method in a case where the imaging element includes a plurality of image sensors.

FIG. 11 is a conceptual diagram describing a scanning method of line illumination with which a target is irradiated.

FIG. 12 is a conceptual diagram describing three-dimensional data (X, Y, A) acquired by a plurality of line illuminations.

FIG. 13 is a diagram illustrating a configuration example of a wavelength of an irradiation unit.

FIG. 14 is a diagram illustrating an example of a block diagram of a control unit.

FIG. 15 is an example of a processing flowchart of imaging processing by the microscope device of the present technology.

FIG. 16 is a diagram for describing a way of setting an imaging region.

FIG. 17 is a diagram for describing a way of setting an imaging region.

FIG. 18 is a diagram for describing a way of setting an imaging region.

FIG. 19 is a diagram for describing a way of setting exposure time.

FIG. 20 is a diagram for describing a way of setting exposure time.

FIG. 21 is a diagram for describing a way of performing imaging control in a case where a target includes a region not to be analyzed.

FIG. 22 is a diagram for describing a way of performing imaging control in a case where a target includes a region not to be analyzed.

FIG. 23 is a diagram for describing a way of performing imaging control in a case where a target includes a region not to be analyzed.

FIG. 24 is a diagram for describing removal of an autofluorescence signal.

FIG. 25 is a diagram for describing removal of an autofluorescence signal.

FIG. 26 is a diagram illustrating a configuration example of an information processing device.

### MODE FOR CARRYING OUT THE INVENTION

Preferred aspects for carrying out the present technology are described below. Note that embodiments described below indicate representative embodiments of the present technology, and the scope of the present technology is not limited only to such embodiments. Note that the present technology will be described in the following order.

1. First embodiment (microscope device)

(1) Description of the first embodiment

(2) First example of the first embodiment

(2-1) First imaging unit

(2-1-1) Determination performed by the first imaging element

(2-1-2) Configuration example of the first imaging element

(2-2) Second imaging unit

(2-2-1) Configuration example of the second imaging unit

(2-3) Control unit

(2-4) Stage

(2-5) First example of imaging control (fluorescence separation processing)

(2-5-1) Processing flow

(2-5-2) Fluorescence separation processing

(2-6) Second example of imaging control (imaging sequence control)

(2-7) Third example of imaging control (imaging parameter control)

(2-8) Fourth example of imaging control (imaging control of target including unnecessary region)

(2-8-1) Imaging control of target including artifact

(2-8-2) Imaging control of target including living tissue not to be analyzed

(3) Second example of the first embodiment

2. Second embodiment (image acquisition system)

3. Second embodiment (image acquisition method)

### 1. First Embodiment (Microscope Device)

(1) Description of the First Embodiment

It is conceivable to use the entire image of the target including the living tissue for controlling imaging for acquiring a more detailed image of the living tissue. In this case, it is conceivable that the entire image data of the target is output from the imaging element that has acquired the image of the entire target to the information processing device connected to the imaging element, and then, the information processing device uses the entire image data for control of processing of acquiring a more detailed image.

However, for example, in a case where the data amount of the entire image data is large, it may take time for the information processing device to receive the entire image data from the imaging element, and this may be rate-limited by, for example, an output interface or a data communication speed of the imaging element. Furthermore, since the information processing of the entire image data is performed by the information processing device, a load is also applied to the information processing device.

A microscope device according to the present technology includes a first imaging element that images an entire target including a living tissue and acquires entire image data and a second imaging element that images the target at a magnification different from that of the first imaging element and acquires image data. The first imaging element includes a determination unit that determines a feature related to the target on the basis of the image data, and the second imaging element is controlled on the basis of a result of the determination. Since the first imaging element includes the determination unit, the first imaging element can output not the image data itself but, for example, data related to the feature of the target, and the second imaging element is controlled on the basis of the data related to the feature. Therefore, the influence of rate limiting described above can be reduced. Furthermore, the data for controlling the second imaging element can be efficiently acquired, and a better partial image can be acquired. As described above, a partial image can be acquired more efficiently or more appropriately with the microscope device according to the present technology.

(2) First Example of the First Embodiment

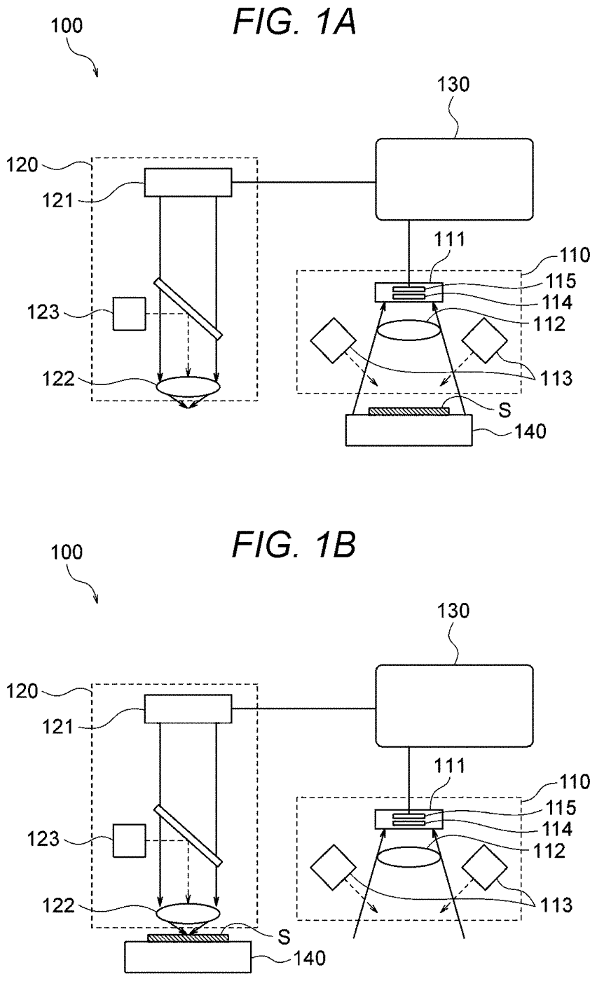

An example of the microscope device according to the present technology and an example of image acquisition processing by the microscope device will be described below with reference to FIG. 1A.

FIG. 1A is a schematic diagram for describing a configuration example of a microscope device according to the present technology. A microscope device 100 illustrated in FIG. 1A includes a first imaging unit 110, a second imaging unit 120, a control unit 130, and a stage 140.

(2-1) First Imaging Unit

As illustrated in FIG. 1A, the first imaging unit 110 includes, for example, a first imaging element 111, a first observation optical system 112, and a first illumination optical system 113. The first imaging unit 110 is configured to be able to image a target S including a living tissue.

The first imaging element 111 images the target S (particularly, the entire target S) including a living tissue and acquires at least one piece of image data (particularly, the entire image data of the target S). The at least one piece of image data may be, for example, bright-field image data and/or fluorescence image data. Furthermore, the image data may be an image signal including a luminance value and/or a frequency.

In addition to an imaging section 114 that acquires the image data of the target S, the first imaging element 111 includes a determination unit 115 that determines a feature related to the target S on the basis of the image data. A configuration example of the first imaging element 111 including the imaging section 114 and the determination unit 115 will be separately described in detail below.

The first observation optical system 112 may be configured such that the first imaging element 111 can enlarge and image the target S. The first observation optical system 112 can include, for example, an objective lens. The objective lens may have, for example, a magnification at which the first imaging element 111 can image the entire target S. Furthermore, the first observation optical system 112 may include a relay lens for relaying the image enlarged by the objective lens to the first imaging element 111. The configuration of the first observation optical system 112 may be appropriately selected by those skilled in the art according to, for example, the target S or the type of image data to be acquired, and may include an optical component other than the objective lens and the relay lens.

The first illumination optical system 113 is an optical system for illuminating the target S during imaging by the first imaging element 111. The first illumination optical system 113 includes a light source for the illumination, and can irradiate the target S with, for example, visible light or ultraviolet light. The light source included in the first illumination optical system 113 may be appropriately selected by those skilled in the art according to the type of image data to be acquired by the first imaging element 111, and can include, for example, at least one selected from a halogen lamp, an LED lamp, a mercury lamp, and a xenon lamp. For example, in a case where the image data is bright-field image data, the first illumination optical system 113 can include, for example, an LED lamp or a halogen lamp. In a case where the image data is fluorescence image data, the first illumination optical system 113 can include, for example, an LED lamp, a mercury lamp, or a xenon lamp. The wavelength of the emitted light or the type of lamp may be selected depending on the type of fluorescent body emitting the fluorescence.

(2-1-1) Determination Performed by the First Imaging Element

The first imaging element 111 includes the determination unit 115 that determines a feature related to the target S on the basis of the image data. The first imaging element 111 may acquire a feature related to the target S as data by the determination. A second imaging element 121 is controlled on the basis of a result of the determination. The feature related to the target S can include, for example, a feature related to a living tissue included in the target S.

The feature related to the target S can include, for example, a feature related to an attribute of the target S. More specifically, the feature related to the attribute of the target S can include one or more selected from a feature related to the attribute of the living tissue, a feature related to an autofluorescence component, and a feature related to a lesion in the living tissue.

The feature related to the attribute of the living tissue can include, for example, a feature related to the type of an organism from which the living tissue is derived, the type of the living tissue, the type of a cell of the living tissue, or a disease that can be possessed by the living tissue.

The type of an organism from which the living tissue is derived may be, for example, a taxonomic type of organism (e.g., human), a gender type (e.g., male or female), or an age-related type (for example, age, month's age, day's age, or the like).

The type of the living tissue can be, for example, the type of an organ from which the living tissue is derived (for example, stomach), the type of a constituent element of an organ (for example, mucosal layer or muscular layer of stomach), or the type of a body fluid (for example, blood).

The type of a cell of the living tissue may be, for example, the type based on classification from the viewpoint of one or more of a form, a function, and a cell constituent component, or the type based on a label (for example, a fluorescent body, an antibody, or the like) attached to the cell.

The feature related to the disease that can be possessed by the living tissue may be, for example, whether or not the living tissue has the disease, the possibility that the living tissue has the disease, or the type of the disease (for example, the name of the disease or the degree of progress of the disease).

The feature related to the target S can include, for example, a feature related to a region of the target S. The feature related to a region of the target S can include, for example, one or more selected from a feature related to a lesion region in the living tissue and a feature related to a foreign substance in the target S. Furthermore, the feature regarding the region of the target S may be a region of a cell, a non-cell region, a region of an organelle (for example, cell nucleus, nucleolus, endoplasmic reticulum, mitochondria, or the like), or the like in the living tissue. The foreign substance in the target may be, for example, dirt or an artifact in the target S.

The feature related to the target S may include, for example, a feature related to arrangement of the target S. The feature related to the arrangement of the target S may be, for example, the inclination of the target S, and more specifically, may be the inclination of a glass slide.

In a preferred embodiment of the present technology, the determination unit 115 performs the determination using a learned model. The learned model may be selected according to a determination result to be acquired. For example, the learned model may be a learned model machine-learned using at least one piece of, preferably a plurality of pieces of, training data including an image of a target including a living tissue and a feature associated with the image (particularly, a feature related to the target).

The learned model may be, for example, a learned model generated by deep learning. For example, the learned model may be a multilayer neural network, may be, for example, a deep neural network (DNN), and may be, more specifically, a convolutional neural network (CNN). The multilayer neural network can include an input layer that inputs image data acquired by the first imaging element, an output layer that outputs image data used to extract a feature related to the target or a feature related to the target, and at least one, for example, two to ten intermediate layers provided between the input layer and the output layer.

In a preferred embodiment of the present technology, the determination unit 115 can determine a feature related to the target by using the learned model, and more specifically, can perform determination related to the attribute of the target and/or determination related to the region of the target. Such determination is performed by the determination unit 115 included in the first imaging element 111, so that control of imaging by the second imaging element 121 or control of processing of a captured image can be performed more efficiently or more appropriately.

(2-1-2) Configuration Example of the First Imaging Element

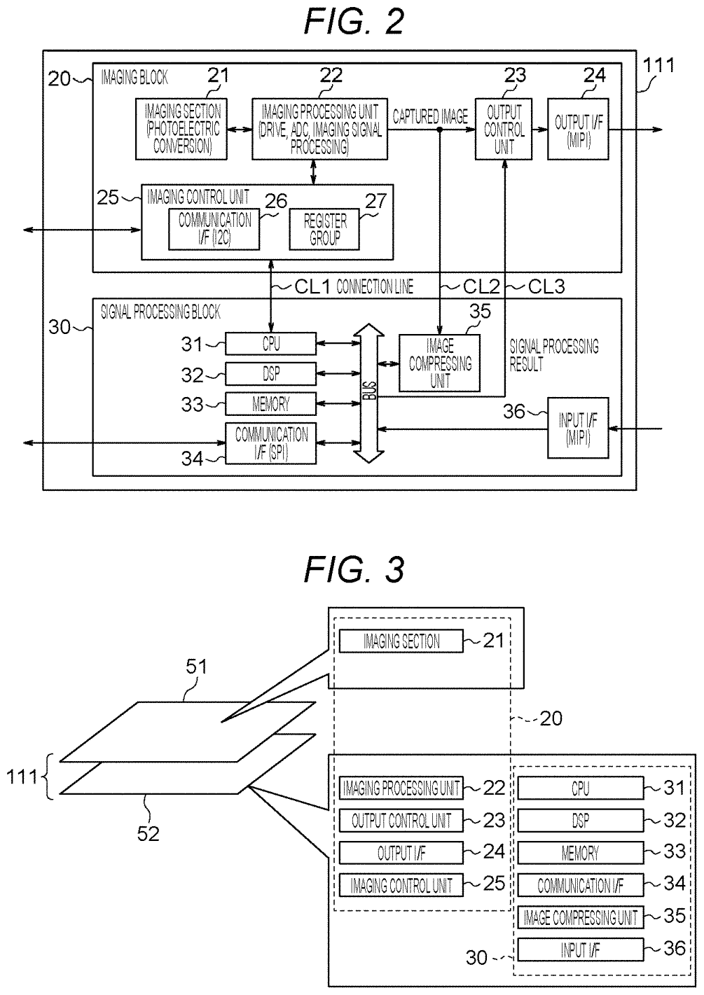

A configuration example of the first imaging element 111 is illustrated in FIG. 2. As illustrated in FIG. 2, the first imaging element 111 includes an imaging block 20 and a signal processing block 30. The imaging block 20 and the signal processing block 30 are electrically connected by connection lines (internal buses) CL1, CL2, and CL3.

The imaging block 20 includes an imaging section 21, an imaging processing unit 22, an output control unit 23, an output I/F 24, and an imaging control unit 25. The imaging section 21 corresponds to the imaging section 114 described above.

The signal processing block 30 can include a central processing unit (CPU) 31, a digital signal processor (DSP) 32, and memory 33. The signal processing block 30 may further include a communication I/F 34, an image compressing unit 35, and an input I/F 36. The signal processing block 30 performs predetermined signal processing using the image data obtained by the imaging block 20 (in particular, the imaging section 21 and the imaging processing unit 22). The determination processing by the determination unit described in “(2-1-1) Determination performed by the first imaging element” described above is achieved by the signal processing block 30.

These constituent elements included in the first imaging element 111 will be described below.

The imaging section 21 images the target S including a living tissue. The imaging section 21 can be driven by, for example, the imaging processing unit 22 to perform the imaging. The imaging section 21 may include, for example, a plurality of pixels arranged in a two-dimensional manner. Each pixel included in the imaging section 21 receives light, performs photoelectric conversion, and then outputs an analog image signal based on the received light.

The size of the image (signal) output by the imaging section 21 can be selected from a plurality of sizes such as 12 M (3968×2976) pixels or a video graphics array (VGA) size (640×480 pixels). The image output by the imaging section 21 may be a color image or a black-and-white image. The color image can be represented by, for example, RGB (red, green, blue). The black-and-white image may be represented, for example, by only luminance. Selection of them can be made as a type of setting of an imaging mode.

The imaging processing unit 22 can perform imaging processing related to imaging of an image by the imaging section 21. For example, under the control of the imaging control unit 25, the imaging processing unit 22 performs driving of the imaging section 21, analog to digital (AD) conversion of an analog image signal output from the imaging section 21, imaging processing of imaging signal processing, or the like.

More specifically, the imaging signal processing can be, for example, processing of obtaining brightness for each of predetermined small regions by calculating an average value of pixel values for each of the small regions, or the like, for an image output from the imaging section 21, processing of converting the image output from the imaging section 21 into a high dynamic range (HDR) image, defect correction, or development.

The imaging processing unit 22 can output a digital image signal (for example, an image of 12 M pixels or VGA size) obtained by AD conversion or the like of the analog image signal output by the imaging section 21 as a captured image.

The captured image output by the imaging processing unit 22 can be supplied to the output control unit 23. Furthermore, the captured image output by the imaging processing unit 22 can be supplied to the signal processing block 30 (in particular, the image compressing unit 35) via the connection line CL2.

The captured image can be supplied from the imaging processing unit 22 to the output control unit 23. Furthermore, the determination result using, for example, captured image data or the like can be supplied from the signal processing block 30 to the output control unit 23 via the connection line CL3.

The output control unit 23 performs output control of selectively outputting the captured image supplied from the imaging processing unit 22 and the determination result by the signal processing block 30 from the (one) output I/F 24 to the outside of the first imaging element 111. Preferably, the imaging element included in the microscope device of the present technology includes an output control unit that performs the output control.

That is, the output control unit 23 selects the captured image from the imaging processing unit 22 or the determination result from the signal processing block 30, and supplies the same to the output I/F 24.

The output I/F 24 is an I/F that outputs the captured image and the determination result supplied from the output control unit 23 to the outside. As the output I/F 24, for example, a relatively high-speed parallel I/F such as a mobile industry processor interface (MIPI) can be adopted. The output I/F 24 outputs the captured image from the imaging processing unit 22 or the determination result from the signal processing block 30 to the outside according to the output control by the output control unit 23. Therefore, for example, in a case where only the determination result from the signal processing block 30 is necessary and the captured image itself is not necessary outside, only the determination result can be output, and the data amount output from the output I/F 24 to the outside can be reduced.

Furthermore, the signal processing block 30 performs determination processing to obtain a determination result used by a constituent element (for example, the second imaging element 121 and/or the control unit 130) external to the first imaging element 111, and the determination result is output from the output I/F 24. Therefore, it is not necessary to perform signal processing outside, and a load on an external block can be reduced.

The imaging control unit 25 can control the imaging processing unit 22 according to imaging information stored in a register group 27, thereby controlling imaging by the imaging section 21.

The register group 27 can store imaging information, a result of the imaging signal processing in the imaging processing unit 22, and output control information related to output control in the output control unit 23. The output control unit 23 can perform output control of selectively outputting the captured image and the determination result according to the output control information stored in the register group 27.

The imaging control unit 25 and the CPU included in the signal processing block 30 may be connected via the connection line CL1. The CPU can read and write information from and to the register group 27 via the connection line. That is, reading and writing of information from and to the register group 27 may be performed by a communication I/F 26 or may be performed by the CPU.

In the signal processing block 30, for example, the CPU 31, the DSP 32, the memory 33, the communication I/F 34, and the input I/F 36 constituting the signal processing block 30 that determines the feature related to the target S on the basis of the at least one piece of image data (particularly, the entire image data of the target S) are connected to each other via a bus, and can exchange information as necessary.

The determination by the signal processing block 30 can be executed, for example, by the signal processing block 30 performing predetermined signal processing using the image data obtained by the imaging section. Hereinafter, the constituent elements that can be included in the signal processing block 30 will be described.

The CPU 31 executes a program stored in the memory 33 to perform various processing, for example, such as control of the signal processing block 30 or reading and writing of information from and to the register group 27 of the imaging control unit 25. For example, by executing the program, the CPU 31 functions as an imaging information calculation unit that calculates imaging information by using a signal processing result obtained by signal processing in the DSP 32, and can feed back new imaging information calculated by using the signal processing result to the register group 27 of the imaging control unit 25 via the connection line CL1 and store the new imaging information. Therefore, the CPU 31 can control imaging by the imaging section 21 and/or imaging signal processing by the imaging processing unit 22 according to the signal processing result of the captured image. Furthermore, the imaging information stored in the register group 27 by the CPU 31 can be provided (output) to the outside from the communication I/F 26. For example, the focus information within the imaging information stored in the register group 27 can be provided from the communication I/F 26 to a focus driver (not illustrated) that controls the focus.

The DSP 32 executes a program stored in the memory 33 to function as a signal processing unit that performs signal processing (for example, determination processing) using image data supplied from the imaging processing unit 22 to the signal processing block 30 via the connection line CL2 and information received by the input I/F 36 from the outside.

The memory 33 can include static random access memory (SRAM), dynamic RAM (DRAM), or the like. The memory 33 stores, for example, various data such as data used for processing of the signal processing block 30.

For example, the memory 33 stores a program received from the outside via the communication I/F 34, captured image data compressed by the image compressing unit 35, particularly, captured image data used in signal processing in the DSP 32, a signal processing result (for example, a determination result) of the signal processing performed by the DSP 32, information received by the input I/F 36, or the like.

The communication I/F 34 is, for example, a second communication I/F such as a serial communication I/F such as a serial peripheral interface (SPI), and exchanges necessary information such as a program executed by the CPU 31 or the DSP 32 with an external constituent element (for example, memory, an information processing device, or the like outside the first imaging element 111).

For example, the communication I/F 34 downloads a program executed by the CPU 31 or the DSP 32 from the outside, supplies the program to the memory 33, and stores the program. Therefore, various processing can be executed by the CPU 31 or the DSP 32 by the program downloaded by the communication I/F 34. Note that the communication I/F 34 can exchange not only the programs but also arbitrary data with the outside. For example, the communication I/F 34 can output the signal processing result obtained by the signal processing in the DSP 32 to the outside. Furthermore, the communication I/F 34 outputs information according to an instruction of the CPU 31 to an external device, so that the external device can be controlled according to the instruction of the CPU 31.

Here, the signal processing result obtained by the signal processing in the DSP 32 can be output from the communication I/F 34 to the outside, and can be written in the register group 27 of the imaging control unit 25 by the CPU 31. The signal processing result written in the register group 27 can be output from the communication I/F 26 to the outside. It is similar regarding a processing result of the processing performed by the CPU 31.

A captured image is supplied from the imaging processing unit 22 to the image compressing unit 35 via the connection line CL2. The image compressing unit 35 performs compression processing for compressing the captured image, and generates a compressed image having a smaller data amount than the captured image.

The compressed image generated by the image compressing unit 35 is supplied to the memory 33 via the bus and stored in the memory 33.

Here, the signal processing in the DSP 32 can be performed using not only the captured image itself but also the compressed image generated from the captured image by the image compressing unit 35. Since the compressed image has a smaller data amount than the captured image, it is possible to reduce the load of signal processing in the DSP 32 and to save the storage capacity of the memory 33 that stores the compressed image.

As the compression processing in the image compressing unit 35, for example, scale-down for converting a captured image of 12 M (3968×2976) pixels into an image of a VGA size can be performed. Furthermore, in a case where the signal processing in the DSP 32 is performed on luminance and the captured image is an RGB image, for example, YUV conversion for converting the RGB image into a YUV image can be performed as the compression processing.

Note that the image compressing unit 35 can be achieved by software or can be achieved by dedicated hardware.

The input I/F 36 is an I/F that receives information from the outside. The input I/F 36 receives, for example, an output of an external sensor (external sensor output) from the external sensor, supplies the output to the memory 33 via the bus, and stores the output in the memory 33.

As the input I/F 36, for example, similarly to the output I/F 24, a parallel I/F such as a mobile industry processor interface (MIPI) or the like can be adopted.

Furthermore, as the external sensor, for example, a distance sensor that senses information regarding distance can be adopted, and furthermore, as the external sensor, for example, an image sensor that senses light and outputs an image corresponding to the light, in other words, an image sensor different from the first imaging element 111 can be adopted.

In the DSP 32, in addition to using (the compressed image generated from) the captured image, the signal processing can be performed using the external sensor output received by the input I/F 36 from the external sensor as described above and stored in the memory 33.

In the one-chip first imaging element 111 configured as described above, the signal processing (for example, determination processing) using a captured image (or a compressed image generated from the captured image) obtained by imaging by the imaging section 21 is performed by the DSP 32, and a signal processing result of the signal processing and the captured image are selectively output from the output I/F 24. Therefore, it is possible to reduce the size of an imaging device that outputs the information necessary for the user.

Here, in a case where the signal processing by the DSP 32 is not performed in the first imaging element 111, and thus, the signal processing result is not output from the first imaging element 111 and a captured image is output, that is, in a case where the first imaging element 111 is configured as an image sensor that merely captures and outputs an image, the first imaging element 111 can include only the imaging block 20 not provided with the output control unit 23.

FIG. 3 is a perspective diagram illustrating an outline of an external configuration example of the first imaging element 111 of FIG. 2.

For example, as illustrated in FIG. 3, the first imaging element 111 can be configured as a one-chip semiconductor device having a stacked structure in which a plurality of dies is stacked. That is, in the present technology, the first imaging element 111 may be configured as an imaging element in which the determination unit and an imaging section that performs imaging are arranged in a single chip.

In FIG. 3, the first imaging element 111 is configured by stacking two sheets of dies: dies 51 and 52.

In FIG. 3, the imaging section 21 is mounted on the upper die 51, and the imaging processing unit 22 to the imaging control unit 25, and the CPU 31 to the input I/F 36 are mounted on the lower die 52. The upper die 51 and the lower die 52 are electrically connected by, for example, forming a through-hole that penetrates the die 51 and reaches the die 52, or performing Cu—Cu bonding for directly connecting a Cu wiring exposed on the lower surface side of the die 51 and a Cu wiring exposed on the upper surface side of the die 52.

Here, in the imaging processing unit 22, as a method of performing AD conversion of the image signal output from the imaging section 21, for example, a column-parallel AD method or an area AD method can be adopted.

In the column-parallel AD method, for example, an AD converter (ADC) is provided for a column of pixels constituting the imaging section 21, and the ADC in each column is in charge of AD conversion of a pixel signal of a pixel in the column, so that AD conversion of an image signal of a pixel in each column in one line is performed in parallel. In a case where the column-parallel AD method is adopted, a part of the imaging processing unit 22 that performs AD conversion of the column-parallel AD method may be mounted on the upper die 51.

In the area AD method, pixels constituting the imaging section 21 are classified into a plurality of blocks, and an ADC is provided for each block. Then, the ADC of each block is in charge of AD conversion of the pixel signals of the pixels of the block, and AD conversion of the image signals of the pixels of the plurality of blocks is performed in parallel. In the area AD method, AD conversion (reading and AD conversion) of an image signal can be performed only for necessary pixels among pixels constituting the imaging section 21 with a block as a minimum unit.

Note that, when the area of the first imaging element 111 is allowed to be large, the first imaging element 111 can include one sheet of die.

Furthermore, in FIG. 3, the one-chip first imaging element 111 is configured by stacking the two sheets of dies 51 and 52, but the one-chip first imaging element 111 can be configured by stacking three or more sheets of dies. In a case where the one-chip first imaging element 111 is configured by stacking three sheets of dies, for example, the memory 33 in FIG. 3 can be mounted on another die.

(2-2) Second Imaging Unit

FIG. 1A illustrates a schematic configuration example of the second imaging unit 120. For example, the second imaging unit 120 may be configured to be able to acquire image data by imaging the target at a magnification different from that of the first imaging unit 110 (more specifically, the first imaging element 111). For example, the second imaging unit 120 may be configured to be able to divide a region imaged by the first imaging unit 110 (more specifically, the first imaging element 111) into a plurality of regions and image the divided regions. The second imaging unit 120 includes the second imaging element 121, a second observation optical system 122, and a second illumination optical system 123.

For example, the second imaging element 121 may be configured to divide a region imaged by the first imaging element 111 into a plurality of regions, image at least one of the plurality of regions, and acquire image data. For example, the second imaging element 121 can image each of the plurality of regions at a higher magnification or a higher resolution than the first imaging element 111.

The second imaging element 121 divides a region imaged by the first imaging element (hereinafter also referred to as an “entire region”) into a plurality of regions and images the regions (hereinafter, the divided regions are also referred to as “divided regions”). Examples of the division method include a line-scan method and a tiling method, but are not limited thereto.

In the line-scan method, the entire region can be divided into a plurality of band-shaped regions. The second imaging element 121 can image each of the plurality of band-shaped divided regions.

In the tiling method, the entire region can be divided into a plurality of tile-shaped regions. The second imaging element 121 can image each of the plurality of tile-shaped divided regions.

The second observation optical system 122 is an optical system configured such that the second imaging element 121 can image an enlarged image of each of the plurality of divided regions. The second observation optical system 122 can include, for example, an objective lens. The objective lens can have a magnification at which the second imaging element 121 can image each of the plurality of divided regions. For example, the objective lens included in the second observation optical system 122 may have a higher magnification than the objective lens included in the first observation optical system 112. Furthermore, the second observation optical system 122 may include a relay lens for relaying the image enlarged by the objective lens to the second imaging element 121.

The second illumination optical system 123 is an optical system for illuminating the target S. The second illumination optical system 123 can irradiate the target S with, for example, visible light or ultraviolet light. The second illumination optical system 123 may be appropriately selected by those skilled in the art according to the type of image data to be acquired, and can include, for example, at least one selected from a halogen lamp, an LED lamp, a mercury lamp, and a xenon lamp. The image data is, for example, fluorescence image data, and in this case, the second illumination optical system 123 can include, for example, an LED lamp, a mercury lamp, or a xenon lamp. The type of lamp may be selected depending on the type of fluorescent body emitting the fluorescence.

When the target S is imaged by the second imaging unit 120, the stage 140 on which the target S is placed can be moved to a position where imaging through the second observation optical system 122 is possible, for example, as illustrated in FIG. 1B. For the movement, the microscope device 100 may include a stage control unit (not illustrated) that moves the stage 140 between the position where imaging can be performed by the first imaging unit 110 and the position where imaging can be performed by the second imaging unit 120. The stage control unit can be controlled, for example, by the control unit 130.

(2-2-1) Configuration Example of the Second Imaging Unit

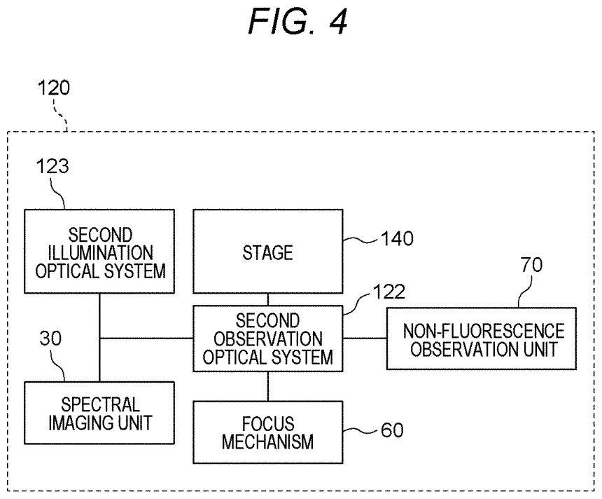

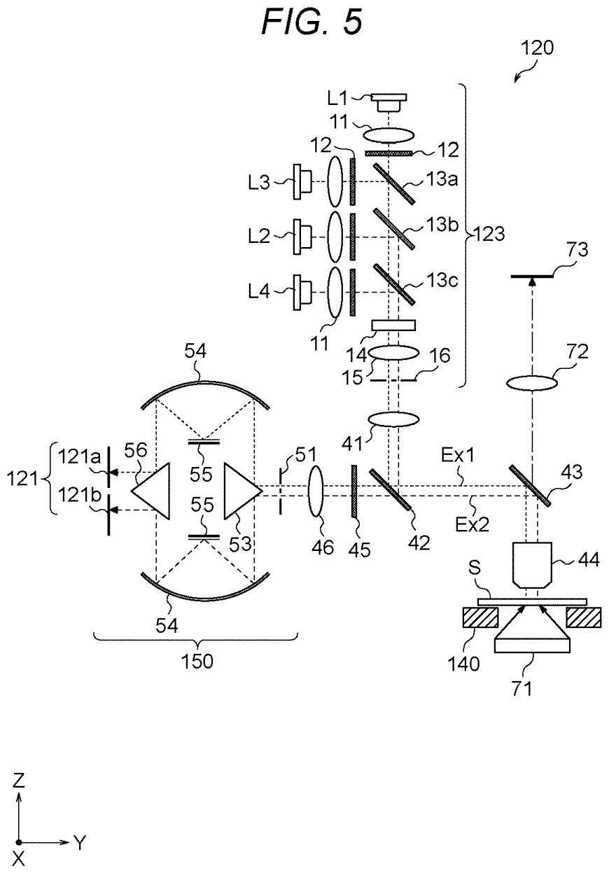

A configuration example in a case where the second imaging unit 120 is an imaging unit that performs imaging by the line-scan method will be described below with reference to FIGS. 4 and 5.

The second imaging unit 120 includes a spectral imaging unit 150 that acquires a fluorescence spectrum (spectral data) of a living tissue excited in a line shape, the second observation optical system 122, and the second illumination optical system 123 that irradiates the target S with a plurality of line illuminations having different wavelengths arranged parallel to each other on different axes. As illustrated in FIG. 5, the spectral imaging unit 150 includes the second imaging element 121. The stage 140 can be moved to a position where imaging can be performed by the second imaging unit 120 after imaging by the first imaging element 111.

Here, being parallel to each other on different axes means that the plurality of line illuminations is on different axes and parallel to each other. Being on different axes means not being on the same axis, and the distance between the axes is not particularly limited. Being parallel to each other is not limited to being accurately parallel to each other, and includes a state of being approximately parallel to each other. For example, there may be a deviation from a parallel state due to a distortion due to an optical system such as a lens, or due to manufacturing tolerances, and such a state is also considered parallel to each other.

The second illumination optical system 123 and the spectral imaging unit 150 are connected to the stage 140 via the second observation optical system 122 including an objective lens 44 or the like. The second observation optical system 122 has a function of following the optimum focus using a focus mechanism 60. A non-fluorescence observation unit 70 that performs dark-field observation, bright-field observation, or the like may be connected to the second observation optical system 122.

The second illumination optical system 123 includes a plurality of light sources L1, L2, . . . , and Ln (n is, for example, 1 to 10, particularly 1 to 8) capable of outputting light of a plurality of excitation wavelengths Ex1, Ex2, . . . , and Exn (n is, for example, 1 to 10, particularly 1 to 8). The plurality of light sources typically includes a light emitting diode (LED), a laser diode (LD), a mercury lamp, and the like, and each light is turned into line illumination and emitted to the target S held on the stage 140.

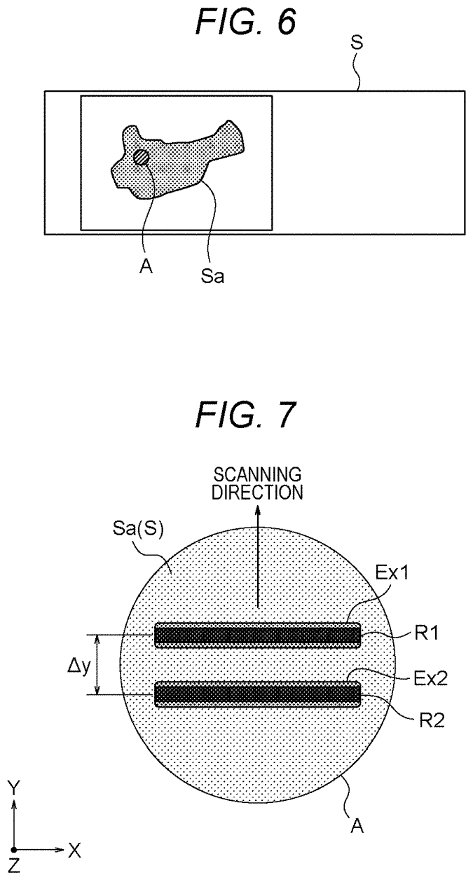

Typically, as illustrated in FIG. 6, the target S includes a slide including a living tissue Sa such as a tissue section, but may of course be other than it. The target S may be stained with a plurality of fluorescent dyes. The second imaging unit 120 enlarges the target S to a desired magnification and observes the target S. When a portion A in FIG. 6 is enlarged, in the second illumination optical system 123, as illustrated in FIG. 7, a plurality of (two (Ex1 and Ex2) in FIG. 7) line illuminations is arranged, and imaging areas R1 and R2 of the spectral imaging unit 150 are arranged so as to overlap the respective illumination areas. The two line illuminations Ex1 and Ex2 are parallel to each other along the X-axis direction, and are arranged at a predetermined distance (Δy) in the Y-axis direction.

The imaging areas R1 and R2 correspond to respective slit portions of an observation slit 51 (FIG. 5) in the spectral imaging unit 150. That is, the same number of slit portions of the spectral imaging unit 150 as the number of line illuminations are arranged. In FIG. 7, the illumination line width is wider than the slit width, but the magnitude relationship may be either one. In a case where the illumination line width is larger than the slit width, the alignment margin of the second illumination optical system 123 with respect to the spectral imaging unit 150 can be increased.

The wavelength constituting the first line illumination Ext and the wavelength constituting the second line illumination Ex2 are different from each other. The line-shaped fluorescence excited by the line illuminations Ex1 and Ex2 is received by the spectral imaging unit 150 via the second observation optical system 122.

The spectral imaging unit 150 includes the observation slit 51 having a plurality of slit portions through which fluorescence excited by the plurality of line illuminations can pass, and at least one second imaging element 121 capable of individually receiving the fluorescence passing through the observation slit 51. The second imaging element 121 adopts a two-dimensional imager such as a charge coupled device (CCD), a complementary metal oxide semiconductor (CMOS), or the like. By arranging the observation slit 51 on the optical path, the fluorescence spectra excited by the respective lines can be detected without overlapping.

The spectral imaging unit 150 acquires spectral data (x, λ) of fluorescence using a pixel array in one direction (for example, a vertical direction) of the imaging element 121 as a channel of a wavelength from each of the line illuminations Ex1 and Ex2. The obtained spectral data (x, λ) is recorded, for example, in the control unit in a state in which the spectral data is associated with that excited by the corresponding excitation wavelength.

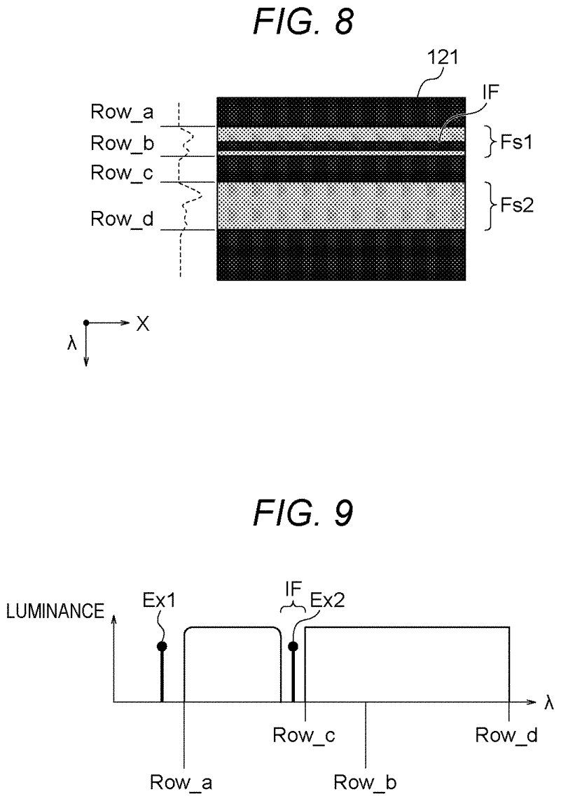

As illustrated in FIG. 5, the second imaging unit 120 is configured such that a dichroic mirror 42 and a band-pass filter 45 are inserted in the middle of the optical path so that the excitation light (Ex1, Ex2) does not reach the second imaging element 121. In this case, an intermittent portion occurs in the fluorescence spectrum formed as an image on the second imaging element 121 (see FIGS. 8 and 9). By excluding the intermittent portion from the reading region, the frame rate can be improved.

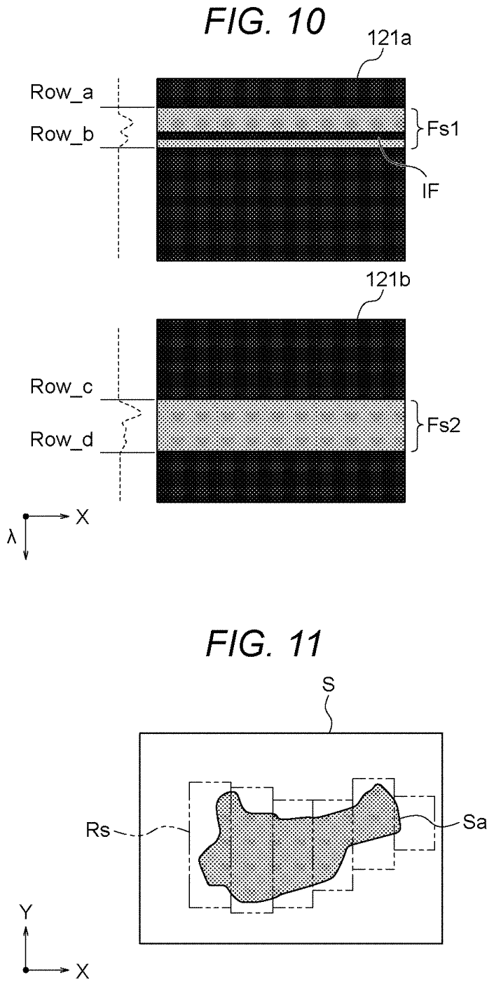

As illustrated in FIG. 5, the second imaging element 121 may include a plurality of imaging elements 121a and 121b capable of respectively receiving fluorescence that has passed through the observation slit 51. In this case, fluorescence spectra Fs1 and Fs2 excited by the respective line illuminations Ex1 and Ex2 are acquired on the imaging elements 121a and 121b as illustrated in FIG. 10, and are stored in association with the excitation light in a storage unit (not illustrated).

The line illuminations Ex1 and Ex2 are not limited to the case of being configured with a single wavelength, and each may be configured with a plurality of wavelengths. In a case where each of the line illuminations Ex1 and Ex2 is configured with a plurality of wavelengths, the fluorescence excited by these also includes a plurality of spectra. In this case, the spectral imaging unit 150 includes a wavelength dispersion element for separating the fluorescence into spectra derived from the excitation wavelength. The wavelength dispersion element includes, for example, a diffraction grating or a prism, and is typically arranged on the optical path between the observation slit 51 and the imaging element 121.

The second imaging unit 120 further includes a scanning mechanism (not illustrated) that scans the stage 140 with the plurality of line illuminations Ex1 and Ex2 in the Y-axis direction, that is, in the arrangement direction of each of the line illuminations Ex1 and Ex2. By using the scanning mechanism, dye spectra (fluorescence spectra) spatially separated by Δy on a sample S (observation target Sa) and excited by different excitation wavelengths can be continuously recorded in the Y-axis direction. In this case, for example, as illustrated in FIG. 11, an imaging region Rs is divided into a plurality of regions in the X-axis direction, and an operation of scanning the sample S in the Y-axis direction, then moving in the X-axis direction, and further performing scanning in the Y-axis direction is repeated. Spectral spectral images derived from the sample excited by several types of excitation wavelengths can be imaged in a single scan.

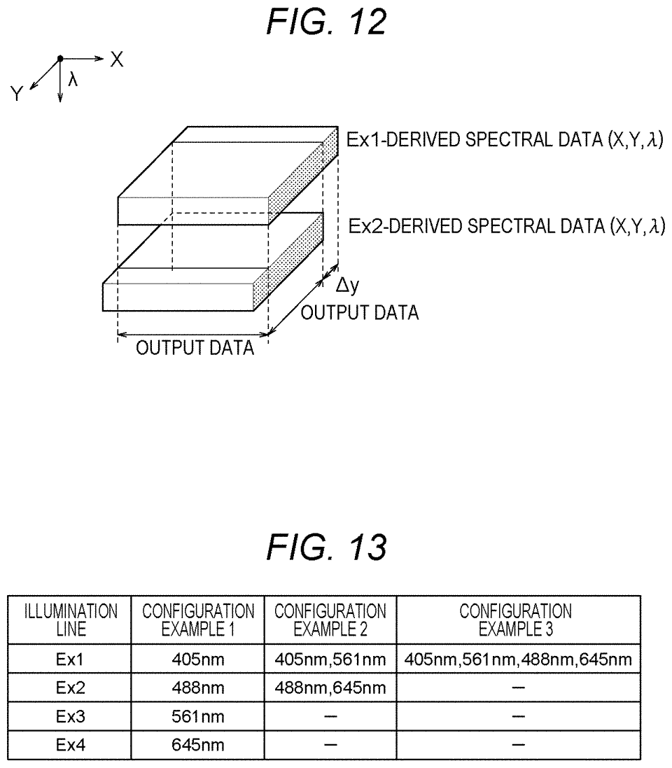

In the scanning mechanism, the stage 140 is typically scanned in the Y-axis direction, but a plurality of line illuminations Ex1 and Ex2 may be scanned in the Y-axis direction by a galvanometer mirror arranged in the middle of the optical system. Finally, three-dimensional data of (X, Y, A) as illustrated in FIG. 12 is acquired for each of the plurality of line illuminations Ex1 and Ex2. Since the three-dimensional data derived from each of the line illuminations Ex1 and Ex2 is data the coordinates of which are shifted by Δy with respect to the Y axis, the three-dimensional data is corrected and output on the basis of Δy recorded in advance or a value of Δy calculated from the output of the second imaging element 121.

In the above example, the number of line illuminations as the excitation light is two, but is not limited thereto, and may be three, four, or five or more. Furthermore, each line illumination may include a plurality of excitation wavelengths selected so that color separation performance does not deteriorate as much as possible. Furthermore, even when there is one line illumination, when the excitation light source including a plurality of excitation wavelengths and the respective excitation wavelengths and Row data acquired by the imaging element are combined and recorded, it is possible to obtain a polychromatic spectrum although it is not possible to obtain separability by being on different axes and parallel to each other. For example, a configuration as illustrated in FIG. 13 may be adopted.

Next, details of the second imaging unit 120 will be described with reference to FIG. 5. Here, an example in which the second imaging unit 120 is configured in Configuration Example 2 in FIG. 13 will be described.

The second illumination optical system 123 includes a plurality of (four in this example) excitation light sources L1, L2, L3, and L4. Each of the excitation light sources L1 to L4 includes a laser light source that outputs a laser beam having a wavelength of 405 nm, 488 nm, 561 nm, and 645 nm, respectively.

The second illumination optical system 123 further includes a plurality of collimator lenses 11 and laser line filters 12 corresponding to the respective excitation light sources L1 to L4, dichroic mirrors 13A, 13B, and 13c, a homogenizer 14, a condenser lens 15, and an incident slit 16.

The laser beam emitted from the excitation light source L1 and the laser beam emitted from the excitation light source L3 are collimated by the collimator lenses 11, transmitted through the laser line filters 12 for cutting the bottom of each wavelength band, and made coaxial by the dichroic mirror 13A. The two coaxial laser beams are further beam-shaped by the homogenizer 14 such as a fly-eye lens and the condenser lens 15 to be the line illumination Ex1.

Similarly, the laser beam emitted from the excitation light source L2 and the laser beam emitted from the excitation light source L4 are made coaxial by the dichroic mirrors 13B and 13c, and turned into a line illumination so as to be the line illumination Ex2 on an axis different from that of the line illumination Ex1. The line illuminations Ex1 and Ex2 form different-axis line illuminations (primary image) that are spaced apart by Δy in the incident slit 16 (slit conjugate) including a plurality of slit portions through which the line illuminations Ex1 and Ex2 can pass.

The primary image is emitted to the target S on the stage 140 through the second observation optical system 122. The second observation optical system 122 includes a condenser lens 41, dichroic mirrors 42 and 43, the objective lens 44, the band-pass filter 45, and a condenser lens 46. The line illuminations Ex1 and Ex2 are collimated by the condenser lens 41 paired with the objective lens 44, are reflected by the dichroic mirrors 42 and 43, are transmitted through the objective lens 44, and emitted to the target S.

The illumination illustrated in FIG. 7 is formed on the target S surface. The fluorescence excited by these illuminations is condensed by the objective lens 44, reflected by the dichroic mirror 43, transmitted through the dichroic mirror 42 and the band-pass filter 45 that cuts off the excitation light, condensed again by the condenser lens 46, and incident on the spectral imaging unit 150.

The spectral imaging unit 150 includes the observation slit 51, the second imaging element 121 (121a, 121b), a first prism 53, mirrors 54, diffraction gratings 55 (wavelength dispersion elements), and a second prism 56.

The observation slit 51 is arranged at the condensing point of the condenser lens 46 and includes the same number of slit portions as the number of excitation lines. The fluorescence spectra derived from the two excitation lines that have passed through the observation slit 51 are separated by the first prism 53 and are both reflected by the grating surface of the diffraction gratings 55 via the mirrors 54, so as to be further separated into fluorescence spectra of respective excitation wavelengths. The four fluorescence spectra thus separated are incident on the imaging elements 121a and 121b via the mirrors 54 and the second prism 56, and developed into (x, λ) information as spectral data.

The pixel size (nm/Pixel) of the second imaging elements 121a and 121b is set to, for example, 2 nm or more and 20 nm or less, but is not limited thereto. This dispersion value may be achieved optically or at a pitch of the diffraction gratings 35, or may be achieved by using hardware binning of the imaging elements 121a and 121b.

The stage 140 and a scanning mechanism 50 constitute an X-Y stage, and move the target S in the X-axis direction and the Y-axis direction in order to acquire a fluorescence image of the target S. In whole slide imaging (WSI), an operation of scanning the target S in the Y-axis direction, then moving the target S in the X-axis direction, and further performing scanning in the Y-axis direction is repeated (see FIG. 11).

The non-fluorescence observation unit 70 includes a light source 71, the dichroic mirror 43, the objective lens 44, a condenser lens 72, an imaging element 73, and the like. In the non-fluorescence observation system, FIG. 5 illustrates an observation system by dark-field illumination.

The light source 71 is arranged below the stage 20, and emits illumination light to the target S on the stage 140 from the side opposite to the line illuminations Ex1 and Ex2. In the case of dark-field illumination, the light source 71 illuminates from the outside of the NA (numerical aperture) of the objective lens 44, and images the light (dark-field image) diffracted by the target S with the imaging element 73 via the objective lens 44, the dichroic mirror 43, and the condenser lens 72. By using dark-field illumination, even an apparently transparent sample such as a fluorescently stained sample can be observed with contrast.

Note that this dark-field image may be observed simultaneously with fluorescence and used for real-time focusing. In this case, as the illumination wavelength, it is sufficient if a wavelength that does not affect fluorescence observation is selected. The non-fluorescence observation unit 70 is not limited to an observation system that acquires a dark-field image, and may include an observation system that can acquire a non-fluorescence image such as a bright-field image, a phase difference image, a phase image, an in-line hologram image, or the like. For example, as a method for acquiring a non-fluorescence image, various observation methods such as the schlieren method, a phase difference contrast method, a polarization observation method, and an epi-illumination method can be adopted. The position of the illumination light source is not limited to the position below the stage, but may be above the stage or around the objective lens. Furthermore, not only a method of performing focus control in real time, but also another method such as a prefocus map method of recording focus coordinates (Z coordinate) in advance may be adopted.

(2-3) Control Unit

For example, the control unit 130 can perform imaging control of the target S by the second imaging element 121 or control processing of an image obtained by the second imaging element 121 on the basis of the determination result by the determination unit 115. By the control unit 130 performing these controls on the basis of the determination result without image data being transmitted from the first imaging element 111 to the control unit 130, the influence of the rate limiting described above is reduced.

Furthermore, the control unit 130 may selectively perform control of the second imaging element 121 based on the image data itself acquired by the first imaging element 111 and control of the second imaging element 121 based on the determination result by the determination unit 115.

The control unit 130 can adjust the positional relationship between the stage 140 and the second imaging element 121 on the basis of the determination result by the determination unit 115, for example, for imaging control of the target S by the second imaging element 121. For the adjustment, for example, the control unit 130 may move the stage 140 or the second imaging element 121, or may move both the stage 140 and the second imaging element 121.

For example, the control unit 130 may adjust the second observation optical system 122 and/or the second illumination optical system 123 in order to perform imaging control of the target S by the second imaging element 121. For example, the control unit 130 can switch the objective lens included in the second observation optical system 122 to an objective lens of another magnification for the imaging control. Furthermore, the control unit 130 can change the illumination light by controlling the light source included in the second illumination optical system 123 for the imaging control.

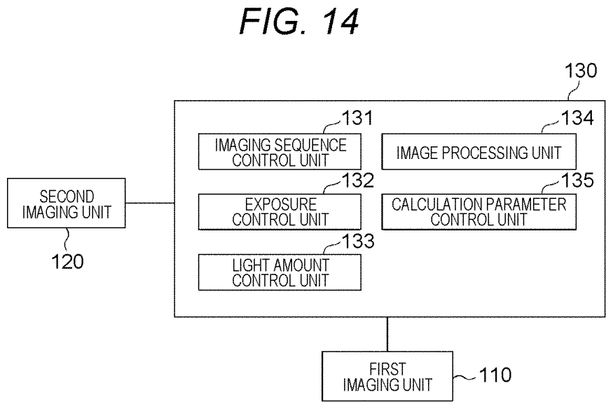

FIG. 14 illustrates an example of a block diagram of the control unit 130. As illustrated in FIG. 14, the control unit 130 can further include at least one selected from an imaging sequence control unit 131, an exposure control unit 132, a light amount control unit 133, an image processing unit 134, a calculation parameter control unit 135, and the like.

The control unit 130 can further include, for example, the imaging sequence control unit 131 that controls the imaging order on the basis of the feature related to the region of the target S. The imaging sequence control unit 131 can image a plurality of portions of the target S more efficiently or more appropriately.

The imaging sequence control unit 131 can perform imaging control so that a joint of the plurality of regions does not overlap the region of interest in the target. Since there is a possibility that the image quality deteriorates at the joint of the plurality of regions, it is possible to prevent the deterioration of the image quality of the region of interest by performing the imaging control as described above.

The imaging sequence control unit 131 can perform imaging control such that the region of interest in the target is imaged a plurality of times. The imaging regions in the plurality of times of imaging may be preferably displaced from each other, but can be set to include the region of interest. More preferably, the imaging region in the plurality of times of imaging can be set such that the region of interest does not overlap the edge of the imaging region of each time.

The control unit 130 may further include the exposure control unit 132 that controls a gain and/or an exposure time. The exposure control unit 132 can control the gain and/or the exposure time on the basis of the feature related to the region of the target. The exposure control unit can control, for example, the gain and/or the exposure time in units of pixels and/or in units of wavelengths.

The exposure control unit 132 can control the gain and/or the exposure time, for example, by controlling any of the second imaging element 121, the second observation optical system 122, and the second illumination optical system 123. For example, the exposure control unit 132 can control the exposure time by controlling a shutter (it may be included in any of the second imaging element 121, the second observation optical system 122, and the second illumination optical system 123). Furthermore, the exposure control unit 132 can control the gain by controlling the second imaging element 121 (for example, an AD converter included in the second imaging element 121).

The control unit 130 can further include the light amount control unit 133 that controls the light amount of the light source. The light amount control unit 133 can control, for example, the light amount of the second illumination optical system 123 of the second imaging unit 120.

The control unit 130 can include the image processing unit 134 that processes an image obtained by the second imaging element 121 and the calculation parameter control unit 135 used in the image processing.

The image processing by the image processing unit 134 can include, for example, fluorescence separation processing. That is, the image processing unit 134 can perform, for example, fluorescence separation processing on the image obtained by the second imaging element 121. The fluorescence separation processing may be, for example, separation processing of separating a fluorescence signal derived from a fluorescent body labeling a living tissue and an autofluorescence signal (for example, an autofluorescence signal derived from a living tissue, an autofluorescence signal derived from an objective lens, and an autofluorescence signal derived from immersion oil), or separation processing of separating fluorescence signals derived from a plurality of fluorescent bodies labeling a living tissue from each other. Details of the fluorescence separation processing by the image processing unit 134 will be described later.

The calculation parameter control unit 135 adjusts a calculation parameter used in the image processing by the image processing unit 134. Preferably, the calculation parameter control unit 135 performs the adjustment on the basis of the result of the determination by the determination unit 115.

The calculation parameter control unit 135 can adjust, for example, an image quality correction parameter. Examples of the image quality correction parameter include a white balance adjustment parameter, a saturation correction parameter, and a contrast correction parameter.

Furthermore, the calculation parameter control unit 135 can adjust a parameter used in the fluorescence separation processing. For example, the calculation parameter control unit can adjust a calculation matrix for the fluorescence separation processing.

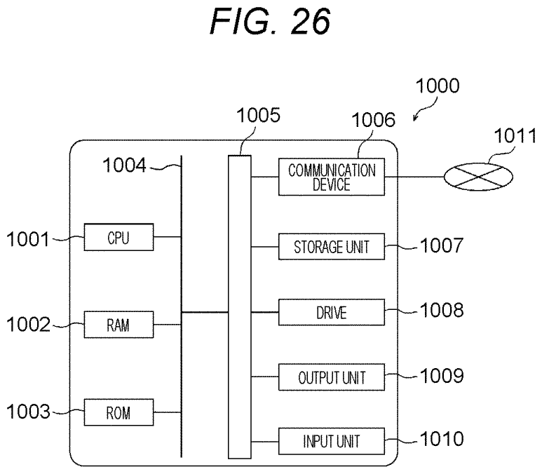

The function (for example, the functions of the imaging sequence control unit, the exposure control unit, the light amount control unit, the image processing unit, and the calculation parameter control unit described above) of the control unit 130 may be achieved by the information processing device. A hardware configuration example of the information processing device for achieving the function of the control unit 130 will be described below with reference to FIG. 26. Note that the configuration of the information processing device is not limited to those described below.

An information processing device 1000 illustrated in FIG. 26 includes a central processing unit (CPU) 1001, RAM 1002, and ROM 1003. The CPU 1001, the RAM 1002, and the ROM 1003 are connected to each other via a bus 1004. An input/output interface 1005 is further connected to the bus 1004.

A communication device 1006, a storage unit 1007, a drive 1008, an output unit 1009, and an input unit 1010 are connected to the input/output interface 1005.

The communication device 1006 connects the information processing device 1000 to a network 1011 by wire or wirelessly. Using the communication device 1006, the information processing device 1000 can acquire various data (for example, image data or the like) via the network 1011. The acquired data can be stored in, for example, a disk 1007. The type of the communication device 1006 may be appropriately selected by those skilled in the art.

The storage unit 1007 can store an operating system (for example, Windows (registered trademark), UNIX (registered trademark), Linux (registered trademark), Android (registered trademark), IOS (registered trademark), or the like), a program for causing the microscope device to execute the image acquisition method according to the present technology, various other programs, and various data (for example, image data and feature data).

The drive 1008 can read data (for example, image data, feature data, or the like) or a program recorded in a recording medium and output the data or the program to the RAM 1002. The recording medium is, for example, but is not limited to, a microSD memory card, an SD memory card, or flash memory.

The output unit 1009 causes an image display unit to output image display light on the basis of the image data. The input unit 1010 receives, for example, an operation of the microscope device by the user.

(2-4) Stage

The stage 140 holds the target S including a living tissue. For example, the target S may be placed on the stage 140, or the target S may be attached to the stage 140. The stage 140 may be configured to be movable. The movement of the stage 140 can be controlled, for example, by the control unit 130.

(2-5) First Example of Imaging Control (Fluorescence Separation Processing)

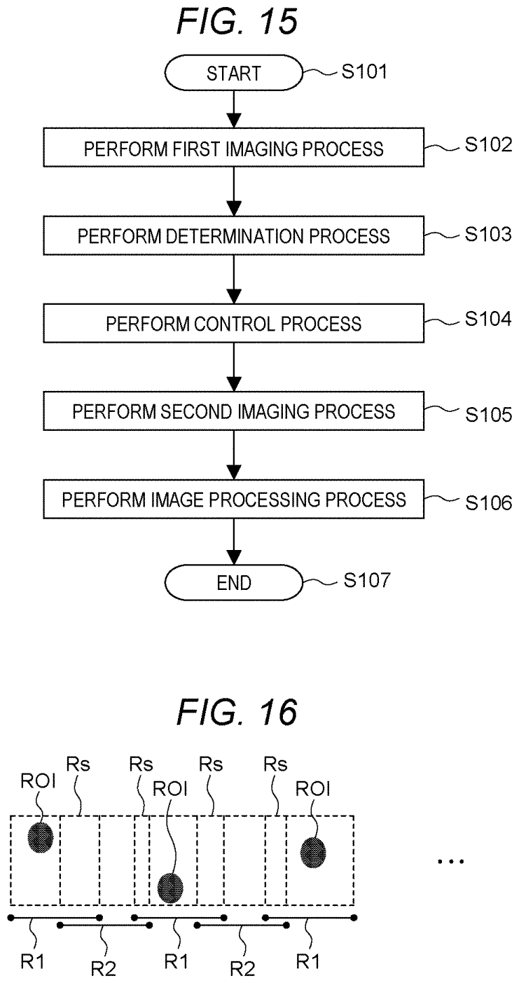

In fluorescence observation of a living tissue, the fluorescence separation processing can be performed. The microscope device of the present technology is suitable for use in the fluorescence observation in which the fluorescence separation processing is performed. Hereinafter, an example in which a living tissue labeled with fluorescence is imaged by the microscope device of the present technology will be described with reference to FIGS. 1A, 1B and 15. FIGS. 1A and 1B are as described above, and FIG. 15 is an example of a processing flowchart of the imaging processing.

(2-5-1) Processing Flow

In step S101 of FIG. 15, imaging processing using the microscope device of the present technology is started. Prior to the start of the imaging processing, the target S including a living tissue is placed on the stage 140 as illustrated in FIG. 1A. Furthermore, the stage 140 is arranged at a position where imaging can be performed by the first imaging unit 110.

In a first imaging process of step S102, the first imaging unit 110 images the target S. The imaging can be performed, for example, in the manner described below.

In step S102, the first illumination optical system 113 irradiates the target S on the stage 140 with light. The light may be, for example, excitation light that excites the fluorescent body included in the target S, particularly, the fluorescent body labeling an observation target region. In step S102, the control unit 130 or the user can control the first illumination optical system 113 to emit the light.

In step S102, the first imaging element 111 images the target S through the first observation optical system 112 in a state where the target S is irradiated with the light, and acquires the image data. The image data may be image data of the entire or a part of the target S. The image data may be image data itself obtained by imaging, compressed image data obtained by compressing image data obtained by imaging, or both the image data and the compressed image data. In particular, the imaging can be performed such that the first imaging element 111 images at least a part of the living tissue included in the target S. The imaging in step S102 can be performed by the control unit 130 or the user controlling the first imaging element 111.

In a determination process of step S103, the first imaging element 111 (in particular, the determination unit 115 included in the first imaging element 111) determines a feature related to the target S on the basis of the image data acquired in step S102. For example, the determination unit 115 can perform determination related to the attribute of the target S, determination related to the region of the target S, or both of them.

For example, the determination unit 115 can determine which organ or site the living tissue included in the target S is derived from or to which tissue the living tissue belongs on the basis of the image data. For example, the determination unit 115 can determine whether the living tissue is the tissue of a brain, an oral cavity, a lung, a trachea, a heart, an esophagus, a stomach, an intestine, a kidney, a liver, a pancreas, a mammary gland, or a skin. Furthermore, the determination unit 115 may determine whether the living tissue belongs to epithelial tissue, connective tissue, muscle tissue, or nerve tissue.

The determination unit 115 may make a determination regarding the size and/or number of constituent elements in the living tissue on the basis of the image data. The constituent element may be, for example, epithelial tissue, connective tissue, muscle tissue, or nerve tissue, or may be a cell or an organelle. More specifically, the determination unit 115 can perform determination regarding the size of an adipose tissue in the living tissue or the size and/or number of red blood cells in the living tissue.

The determination unit 115 may determine whether the living tissue has a lesion portion, determine what disease the living tissue has, or determine the degree of progress of the disease on the basis of the image data.

The determination unit 115 may determine the autofluorescence level on the basis of the image data. The autofluorescence may be, for example, autofluorescence derived from the living tissue, autofluorescence derived from an encapsulating material for encapsulating the living tissue, or autofluorescence (for example, autofluorescence derived from the objective lens of the first observation optical system 112, autofluorescence of immersion oil, or the like) derived from an imaging environment. Regarding the encapsulating material, the spectrum or luminance can vary depending on, for example, a medium or a drug used for encapsulating tissue between a glass slide and a cover glass.

The determination unit 115 preferably determines the feature related to the target S using the learned model. For example, the learned model may be generated by using one or a plurality of combinations of image data of a target including a living tissue and a feature related to the target as training data. Regarding the learned model, the description in “(2-1-1) Determination performed by the first imaging element” described above also applies to the present example.

In step S103, the first imaging element 111 transmits the determination result by the determination unit 115 to the control unit 130. In step S103, for example, in addition to the determination result, the image data and/or the compressed image data of the target S may be transmitted to the control unit 130, but preferably, the image data and/or the compressed image data of the target S are not transmitted to the control unit 130. As described above, the first imaging element 111 outputs only the determination result to the control unit 130 to reduce the influence of rate limiting by the output interface or the like of the first imaging element 111. Furthermore, since the control unit 130 receives only the determination result, the processing load on the control unit 130 is reduced.

In a control process of step S104, the control unit 130 receives the determination result transmitted from the first imaging element 111. On the basis of the determination result, the control unit 130 can generate imaging control data for controlling imaging by the second imaging unit 120, image processing control data for controlling processing of image data obtained by imaging by the second imaging unit 120, or both of these data.

The imaging control data includes, for example, imaging control data regarding a way of division imaging by the second imaging element 121, and more specifically, for example, data regarding a way of division, an imaging order of divided regions, an imaging condition (for example, magnification, gain, exposure time, light amount, or the like), or the like. Preferably, the control unit 130 can set the way of division so that the region of interest (for example, disease region, in particular tumor region) in the target S does not overlap the joint of the divided regions. Although there is a possibility that the image quality deteriorates at the joint of the divided regions, the image quality deterioration of the region of interest can be prevented by the control unit setting the way of division in this manner.

The imaging control data can be generated by, for example, the imaging sequence control unit 131, the exposure control unit 132, or the light amount control unit 133 described above.

The image processing control data can include, for example, data for controlling the image processing performed by the control unit 130 in step S106 described later. More specifically, the image processing control data may be data related to a way of joining the plurality of pieces of image data acquired in step S105, data related to a way of image processing of each of the plurality of pieces of image data, and data related to the fluorescence separation processing in step S106.

The image processing control data can be generated by, for example, the image processing unit 134 or the calculation parameter control unit described above.

In a second imaging process of step S105, the control unit 130 can control the second imaging unit 120 on the basis of the imaging control data generated in step S104 to cause the second imaging unit 120 to image the target S. The imaging will be described in more detail below.

Note that prior to the imaging, the control unit 130 can move the stage 140 on which the target S is placed to a position where imaging can be performed by the second imaging unit 120. An example of the state after the movement is illustrated in FIG. 1B. Alternatively, the control unit 130 may drive a device that moves or operates the target S, and the device may move the target S from the stage 140 to a stage separately provided in the second imaging unit 120.

For example, in step S105, the second illumination optical system 123 irradiates the target S on the stage 140 with excitation light of the fluorescent body included in the target S. The excitation light may be the same as or different from the light emitted in step S102. In step S105, the control unit 130 or the user can control the second illumination optical system 123 to emit the excitation light.

In step S105, the second imaging element 121 can image the target S, for example, at a magnification different from that of the first imaging element 111 on the basis of the imaging control data in a state where the target S is irradiated with the light. For example, the second imaging element 121 can divide the region imaged by the first imaging element 111 into a plurality of regions and image the divided regions on the basis of the imaging control data. For example, the second imaging element 121 performs imaging a plurality of times, thereby obtaining a plurality of pieces of image data (hereinafter also referred to as “divided image data”). The division imaging can be performed by, for example, the tiling method or the line-scan method.

In step S105, the second imaging element 121 receives the fluorescence generated from the target S by the excitation light irradiation through the second observation optical system 122. The second observation optical system 122 can include a wavelength separation element (for example, a filter or a spectroscope) in order to separate and receive desired fluorescence.

The second imaging element 121 transmits image data (one or a plurality of pieces of divided image data, in particular, a plurality of pieces of divided image data) acquired by imaging in step S105 to the control unit 130.

In an image processing process of step S106, the control unit 130 receives the image data (one or a plurality of pieces of divided image data, in particular, a plurality of pieces of divided image data) acquired in step S105, and performs the image processing using the image data. The control unit 130 can perform the image processing, for example, on the basis of the image processing control data.

For example, in step S106, the control unit 130 can generate one piece of image data related to regions of two or more pieces of divided image data by using two or more pieces of divided image data among the plurality of pieces of divided image data. For example, the control unit 130 can generate image data of the entire region imaged in step S102 using the plurality of pieces of image data.

Furthermore, in step S106, the control unit 130 can perform the fluorescence separation processing on the image data (one or a plurality of pieces of divided image data, in particular, a plurality of pieces of divided image data). In step S106, the control unit 130 may perform the fluorescence separation processing on the image data of the entire region imaged in step S102. The fluorescence separation processing may be, for example, separation processing of separating a fluorescence signal derived from a fluorescent body labeling a living tissue and an autofluorescence signal, or separation processing of separating fluorescence signals derived from a plurality of fluorescent bodies labeling a living tissue from each other.

Details of the fluorescence separation processing will be separately described in “(2-5-2) Fluorescence separation processing” below.

The image data generated by the image processing in step S106 may be stored in, for example, a storage medium provided in the microscope device 100, or may be output to an external storage medium connected to the microscope device 100 by wire or wirelessly.

In step S107, the microscope device 100 ends the imaging processing.

Through the image acquisition processing described above, the second imaging element 121 is controlled without transmitting the image data from the first imaging element 111 to the control unit 130. Therefore, efficient or appropriate image acquisition becomes possible.

(2-5-2) Fluorescence Separation Processing

In step S106, the image processing unit 134 included in the control unit 130 can perform, for example, the fluorescence separation processing of separating an autofluorescence signal of a living tissue and a fluorescence signal of at least one fluorescent body from the image data of the living tissue labeled with at least one fluorescent body. Furthermore, the image processing unit 134 can perform the fluorescence separation processing of separating fluorescence signals of each of two or more fluorescent bodies from the image data of a biological dye labeled with two or more fluorescent bodies. These pieces of fluorescence separation processing may be performed, for example, on the basis of information regarding a living tissue and information regarding a fluorescent body.

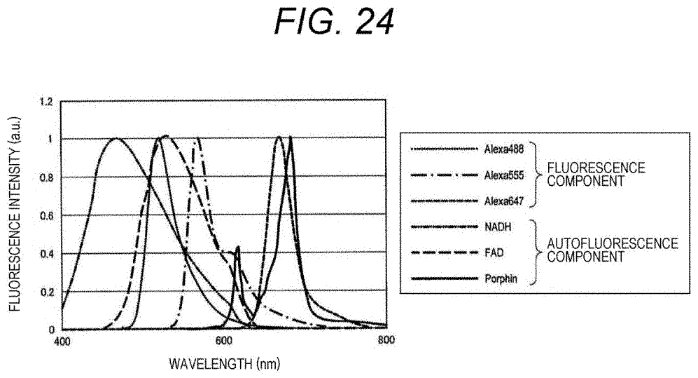

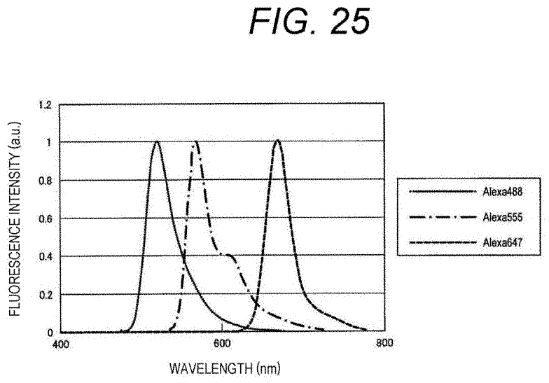

Here, the “information regarding a living tissue” (hereinafter, referred to as “living tissue information” for convenience) is information including a measurement channel and spectral information unique to the autofluorescence component included in the living tissue. The “measurement channel” is a concept indicating one or more elements constituting an autofluorescence signal. More specifically, the autofluorescence spectrum is a mixture of fluorescence spectra of one or more autofluorescence components. For example, FIG. 24 illustrates fluorescence spectra including autofluorescence in a case where Alexa Fluor 488 (indicated as “Alexa 488” in the drawing), Alexa Fluor 555 (indicated as “Alexa 555” in the drawing), and Alexa Fluor 647 (indicated as “Alexa 647” in the drawing) were used as fluorescent reagents. Examples of the autofluorescence component include nicotinamide adenine dinucleotide reduced form (NADH), flavin adenine dinucleotide (FAD), and porphin, and a mixture of the fluorescence spectra of these autofluorescence components is included as an autofluorescence spectrum in FIG. 24. The measurement channel according to the present technology is a concept indicating NADH, FAD, and porphin constituting the autofluorescence spectrum in the example of FIG. 24, and a total of three channels are used (in other words, the measurement channel according to the present technology is information indicating an autofluorescence component included in a living tissue). Since the number of autofluorescence components varies with the living tissue, the measurement channel is managed in association with each living tissue as living tissue information. Furthermore, the “spectral information” included in the living tissue information is information regarding an autofluorescence spectrum of each autofluorescence component included in each living tissue. Note that the content of the living tissue information is not limited to the above. The living tissue information will be described in more detail later.

The “information regarding a fluorescent body” (hereinafter, referred to as “fluorescent body information” for convenience) is information including spectral information of a fluorescence component included in the fluorescent body. The “spectral information” included in the fluorescent body information is information regarding a fluorescence spectrum of each fluorescence component included in each fluorescent body. Note that the content of the fluorescent body information is not limited to the above. The fluorescent body information will be described in more detail later.

The image processing unit 134 can extract the fluorescence signal of the fluorescent body by estimating the autofluorescence signal derived from the living tissue on the basis of the measurement channel and the spectral information included in the living tissue information and the spectral information included in the fluorescent body information, and by removing the autofluorescence signal from the image data. For example, the image processing unit 134 can extract fluorescence signals from Alexa Fluor 488, Alexa Fluor 555, and Alexa Fluor 647 as illustrated in FIG. 25 by removing the autofluorescence signals from NADH, FAD, and porphin, which are autofluorescence components, from the image information.

In the above processing by the image processing unit 134, it is not necessary to measure the fluorescence signal of an unlabeled living tissue for autofluorescence signal subtraction processing, so that the burden on the user is reduced. Furthermore, the image processing unit 134 can separate the autofluorescence signal and the fluorescence signal with higher accuracy by using not either the living tissue information or the fluorescent body information, but both the living tissue information and the fluorescent body information.

Furthermore, conventionally, in order to acquire a fluorescence signal to be measured, a method of amplifying a fluorescence signal to be measured to such an extent that an autofluorescence signal derived from a living tissue can be negligible is widely and generally performed, but, it is difficult to acquire an autofluorescence signal derived from a living tissue in the fluorescence separation processing described above. On the other hand, the image processing unit 134 can extract the autofluorescence signal derived from the living tissue from the image data. Therefore, the image processing unit 134 can perform segmentation (or region division) for recognizing the region of an object (for example, a cell, an intracellular structure (cytoplasm, cell membrane, nucleus, or the like), or tissue (tumor site, non-tumor site, connective tissue, blood vessel, blood vessel wall, lymphatic vessel, fibrosed structure, necrosis, or the like)) included in the image data on the basis of the distribution of the autofluorescence signal and the fluorescence signal in the image data.

Furthermore, since the autofluorescence signal of the entire living tissue changes depending on the immobilization state of the living tissue (for example, an immobilization method or the like), the image processing unit 134 can analyze (evaluate) the immobilization state of the living tissue on the basis of the extracted autofluorescence signal. More specifically, the image processing unit 134 can analyze the immobilization state of the living tissue on the basis of the composition ratio of the autofluorescence signals of each of the two or more components that emit autofluorescence.

More specifically, the image processing unit 134 recognizes one or more elements constituting the autofluorescence signal on the basis of the measurement channel included in the living tissue information. For example, the image processing unit 134 recognizes one or more autofluorescence components constituting the autofluorescence signal. Then, the image processing unit 134 predicts or estimates the autofluorescence signal included in the image data using the spectral information of these autofluorescence components included in the living tissue information. Then, the image processing unit 134 separates the autofluorescence signal and the fluorescence signal from the image data on the basis of the spectral information of the fluorescence component of the fluorescent body included in the fluorescent body information the predicted or estimated autofluorescence signal.

Here, in a case where the living tissue is stained with two or more fluorescent bodies, the image processing unit 134 separates the fluorescence signal of each of the two or more fluorescent bodies from the image data (alternatively, the fluorescence signal after separated from the autofluorescence signal) on the basis of the living tissue information and the fluorescent body information. For example, the image processing unit 134 separates the fluorescence signal of each fluorescent body from the entire fluorescence signal after separated from the autofluorescence signal by using the spectral information of the fluorescence component of each fluorescent body included in the fluorescent body information.

Furthermore, in a case where the autofluorescence signal includes two or more autofluorescence components, the image processing unit 134 separates the autofluorescence signal of each autofluorescence component from the image data (alternatively, the autofluorescence signal after separated from the fluorescence signal) on the basis of the living tissue information and the fluorescent body information. For example, the image processing unit 134 separates the autofluorescence signal of each autofluorescence component from the entire autofluorescence signal after separated from the fluorescence signal by using the spectral information of each autofluorescence component included in the living tissue information.

The image processing unit 134 that has separated the fluorescence signal and the autofluorescence signal performs various types of processing using these signals. For example, the image processing unit 134 may extract the fluorescence signal from the image data of another living tissue by performing subtraction processing (also referred to as “background subtraction processing”) on the image data of the another living tissue using the autofluorescence signal after separation. In a case where there is a plurality of living tissues that is the same or similar in terms of the tissue used for the living tissue, the type of a target illness, the attribute of a target person, the lifestyle of a target person, and the like, there is a high possibility that the autofluorescence signals of these living tissues are similar. A similar specimen referred to herein includes, for example, a tissue section before staining of the tissue section to be stained (hereinafter referred to as a section), a section adjacent to the stained section, a section different from the stained section in the same block (sampled from the same place as the stained section), a section or the like from a different block (sampled from a different place from the stained section) in a different block in the same tissue, a section collected from a different patient, or the like. Therefore, in a case where the autofluorescence signal can be extracted from a certain living tissue, the image processing unit 134 may extract the fluorescence signal from the image data of another living tissue by removing the autofluorescence signal from the image data of the another living tissue. Furthermore, when calculating an S/N value using the image data of the another living tissue, the image processing unit 134 can improve the S/N value by using the background after removing the autofluorescence signal.

Furthermore, in addition to the background subtraction processing, the image processing unit 134 can perform various processing using the fluorescence signal or autofluorescence signal after separation. For example, the image processing unit 134 can analyze the immobilization state of a living tissue by using these signals or perform segmentation (or region division) for recognizing the region of an object (for example, a cell, an intracellular structure (cytoplasm, cell membrane, nucleus, or the like), or tissue (tumor site, non-tumor site, connective tissue, blood vessel, blood vessel wall, lymphatic vessel, fibrosed structure, necrosis, or the like)) included in the image data. The analysis of the immobilization state of the living tissue and the segmentation will be described in detail later.

The image processing unit 134 can generate (reconfigure) image data on the basis of the fluorescence signal or the autofluorescence signal separated by the fluorescence separation processing described above. For example, the image processing unit 134 can generate image data including only a fluorescence signal or generate image data including only an autofluorescence signal. At that time, in a case where the fluorescence signal is configured with a plurality of fluorescence components or the autofluorescence signal is configured with a plurality of autofluorescence components, the image processing unit 134 can generate image data in units of these components. Moreover, in a case where the image processing unit 134 performs various types of processing (for example, analysis of the immobilization state of a living tissue, segmentation, calculation of an S/N value, or the like) using the fluorescence signal or the autofluorescence signal after separation, the image processing unit 134 may generate image data indicating a result of the processing. By the image generation by the image processing unit 134, the distribution information of the fluorescent body labeling a target molecule, that is, the two-dimensional spread and intensity of the fluorescence, the wavelength, and the positional relationship thereof are visualized, and in particular, it is possible to improve the visibility of a doctor or a researcher who is a user in a tissue image analysis region in which the information of a target substance is complicated.

Furthermore, the image processing unit 134 may perform control so as to distinguish the fluorescence signal with respect to the autofluorescence signal on the basis of the fluorescence signal or the autofluorescence signal separated by the fluorescence separation processing described above and to generate image data. Specifically, the image data may be generated by controlling, for example, improving the luminance of the fluorescence spectrum of the fluorescent body labeling a target molecule, extracting and changing the color of only the fluorescence spectrum of the labeled fluorescent body, extracting the fluorescence spectra of two or more fluorescent bodies from the living tissue labeled with two or more fluorescent bodies and changing each of the fluorescence spectra to a different color, extracting and dividing or subtracting only the autofluorescence spectrum of the living tissue, and improving the dynamic range. Thus, the user can clearly distinguish the color information derived from the fluorescent body bound to an objective target substance, and the visibility of the user can be improved.

(2-6) Second Example of Imaging Control (Imaging Sequence Control)

In the case of microscopic observation of a living tissue, for example, by imaging an objective living tissue with high image quality and imaging another region with low image quality, the data amount to be generated can be reduced. The microscope device of the present technology is suitable for selectively imaging an objective living tissue with high image quality. For example, with the microscope device of the present technology, it is possible to image a region including a region of an objective living tissue (hereinafter also referred to as a “region of interest”) with high image quality and image a region not including the region of interest with low image quality. As described above, the microscope device of the present technology can change the imaging condition according to the imaging region, and thus can reduce the amount of generated image data. Hereinafter, an example of such imaging processing will be described.

An example of imaging processing in which extraction of a region of interest is performed by the microscope device of the present technology and an imaging sequence of the microscope device is controlled on the basis of a result of the extraction will be described with reference to FIGS. 1A, 1B and 15.

Steps S101 and S102 are as described above in “(2-5) First example of imaging control (fluorescence separation processing)”, and the description is also applied to the present example.

In the determination process of step S103, the first imaging element 111 (in particular, the determination unit 115) determines a feature related to the target S on the basis of the image data acquired in step S102. For example, the determination unit 115 can perform determination related to the region of the target S. Furthermore, in addition to the determination related to the region of the target S, the determination unit 115 may perform determination related to the attribute of the target S.

For example, the determination unit 115 can perform determination related to the region of the target S on the basis of the image data. For example, the determination unit 115 can extract the region of interest in the target S by the determination. The region of interest may be, for example, a region of a specific cell or tissue, a lesion region, or the like. Furthermore, the determination unit 115 may extract a region of a non-objective object by the determination. The non-objective object may be, for example, dirt or an artifact.

For example, the determination unit 115 can generate image data in which a region imaged by the first imaging element 111 is distinguished into a region of interest and another region on the basis of the result of determination related to the region of the target S. For the distinction, for example, a predetermined class can be assigned to the region of interest, and a class different from the class can be assigned to the another region. These classes may be associated in advance with the features of each of these regions.

The determination unit 115 preferably determines the feature related to the target S using the learned model. For example, the learned model may be generated by using one or a plurality of combinations of image data of a target including a living tissue and a feature related to the target as training data. Regarding the learned model, the description in “(2-1-1) Determination performed by the first imaging element” described above also applies to the present example.

In step S103, the first imaging element 111 transmits the determination result by the determination unit 115 to the control unit 130.

In a control process of step S104, the control unit 130 receives the determination result transmitted from the first imaging element 111. On the basis of the determination result, the control unit 130 can generate imaging control data for controlling imaging by the second imaging unit 120, image processing control data for controlling processing of image data obtained by imaging by the second imaging unit 120, or both of these data.

For example, the control unit 130 can generate, as the imaging control data, imaging control data related to a way of division imaging by the second imaging element 121. The imaging control data can include, for example, data related to a way of setting the imaging region, a way of division, an order of imaging the divided regions, imaging conditions (for example, magnification, gain, exposure time, light amount, and the like), or the like.

The imaging control data generated by the control unit 130 can include, for example, an imaging condition for a region including the region of interest and an imaging condition for a region other than the region of interest. For example, these imaging conditions can be set such that the resolution or magnification in the imaging of the region including the region of interest is higher than the resolution or magnification in the imaging of the region other than the region of interest.

The imaging control data generated by the control unit 130 can include, for example, data related to the way of division. For example, the control unit 130 can divide the region imaged by the first imaging element 111 into a region including the region of interest and a region not including the region of interest on the basis of the determination result in step S203.

For example, as illustrated in FIG. 16, the control unit 130 can divide a region R imaged by the first imaging element 111 into a region R1 including a region of interest ROI and a region R2 not including the region of interest ROI.

For example, as illustrated in FIG. 16, the regions R1 and R2 can be set such that a joint region Rs in which a part of the region R1 and a part of the region R2 overlap each other exists. As described above, preferably, the control unit 130 can set the joints of the plurality of divided regions to overlap each other. The joint region enables more accurate reconfiguration in a case where the images of the plurality of regions are joined to reconfigure the entire image.

For example, as illustrated in FIG. 16, the regions R1 and R2 can be set such that the region of interest ROI is not included in the joint region Rs. As described above, preferably, the control unit 130 can set the plurality of regions such that the region of interest does not overlap the joint region of the plurality of divided regions.

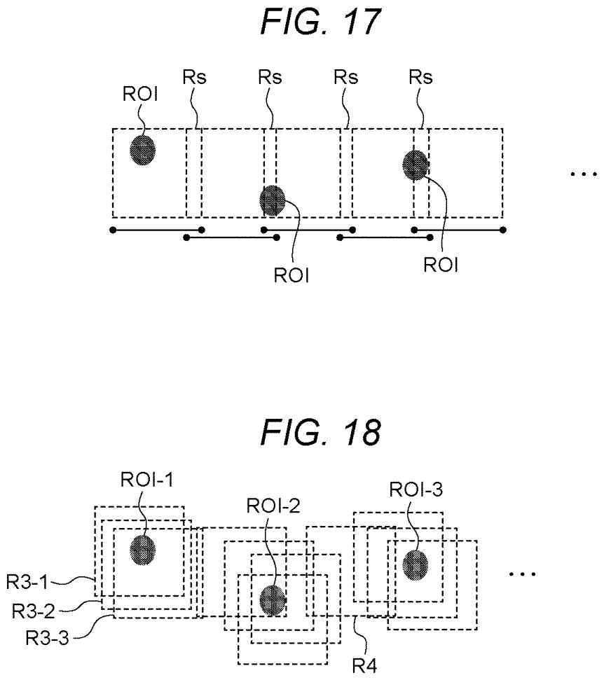

Note that there is a case where the image quality of the joint region Rs deteriorates. Therefore, as illustrated in FIG. 17, in a case where the region of interest ROI is included in the joint region Rs, there is a case where the image quality of the region of interest ROI deteriorates.

Furthermore, as illustrated in FIG. 18, the control unit 130 may set a plurality of imaging regions R3 for one region of interest ROI. In FIG. 18, imaging regions R3-1, R3-2, and R3-3 are set for a region of interest ROI-1, that is, all of the imaging regions R3-1, R3-2, and R3-3 include the region of interest ROI-1. Therefore, the image quality of the region of interest ROI-1 can be improved. As described above, preferably, the control unit 130 can set the imaging condition such that imaging is performed a plurality of times for one region of interest.

Note that, for the region not including the region of interest ROI, as illustrated in FIG. 18, one imaging region R4 may be set.

Furthermore, in a case where a plurality of times of imaging is performed for the one region of interest ROI-1, as illustrated in FIG. 18, the control unit 130 can set the imaging regions R3-1, R3-2, and R3-3 of the plurality of times of imaging to be displaced from each other. Therefore, the image quality of the region of interest ROI-1 can be improved. In this manner, preferably, the control unit 130 can set a plurality of imaging regions including the region of interest and displaced from each other with respect to one region of interest.

In step S104, the control unit 130 transmits the generated imaging control data to the second imaging unit 120 (for example, the second imaging element 121 or the like).

In the second imaging process of step S105, the second imaging unit 120 receives the imaging control data generated in step S104, and images the target S on the basis of the imaging control data. Prior to the imaging, the control unit 130 moves the stage 140 on which the target S is placed to a position where imaging can be performed by the second imaging unit 120.

For example, in step S105, the second illumination optical system 123 irradiates the target S on the stage 140 with excitation light of the fluorescent body included in the target S. The excitation light may be the same as or different from the light emitted in step S102. In step S105, the control unit 130 or the user can control the second illumination optical system 123 to emit the excitation light.

In step S105, for example, the second imaging element 121 can image the target S at a magnification different from that of the first imaging element 111 on the basis of the imaging control data and acquire the image data in a state where the target S is irradiated with the light. For example, the second imaging element 121 may divide a region imaged by the first imaging element 111 into a plurality of regions, image at least one of the plurality of regions, and acquire the image data on the basis of the imaging control data. That is, the region imaged by the first imaging element 111 can be divided into a plurality of regions and imaged. As described above, the second imaging element 121 may perform imaging a plurality of times, thereby obtaining a plurality of pieces of image data.

In step S105, the second imaging element 121 receives the fluorescence generated from the target S by the excitation light irradiation through the second observation optical system 122. The second observation optical system 122 can include a wavelength separation element (for example, a filter or a spectroscope) in order to separate and receive desired fluorescence.

The second imaging element 121 transmits image data (one or a plurality of pieces of image data, in particular, a plurality of pieces of image data) acquired by imaging in step S105 to the control unit 130.

In the image processing process of step S106, the control unit 130 receives the image data (one or a plurality of pieces of image data, in particular, a plurality of pieces of image data) acquired in step S105, and performs the image processing using the plurality of pieces of image data.

For example, in step S106, the control unit 130 can generate one piece of image data by using two or more pieces of image data of the plurality of pieces of image data. For example, the control unit 130 can generate image data of the entire region imaged in step S102 using the plurality of pieces of image data.

The image data generated by the image processing in step S106 may be stored in, for example, a storage medium provided in the microscope device 100, or may be stored in an external storage medium connected to the microscope device 100 by wire or wirelessly.

In step S107, the microscope device 100 ends the imaging processing.

(2-7) Third Example of Imaging Control (Imaging Parameter Control)

In a case where imaging is performed without setting an appropriate exposure time for signal intensity, blown-out highlights or blocked up shadows can occur in an image obtained by imaging. Therefore, it is desirable to adjust the exposure time. Such adjustment can be performed by the microscope device of the present technology.

An example of imaging processing in which extraction of a region of interest is performed by the microscope device of the present technology and imaging parameters (for example, exposure time and/or gain) of the microscope device is controlled on the basis of a result of the extraction will be described with reference to FIGS. 1A, 1B and 15.

Steps S101 and S102 in FIG. 15 are as described above in “(2-5) First example of imaging control (fluorescence separation processing)”, and the description is also applied to the present example.

In the determination process of step S103, the first imaging element 111 (in particular, the determination unit 115) determines a feature related to the target S on the basis of the image data acquired in step S102. For example, the determination unit 115 can perform determination related to the region of the target S. Furthermore, in addition to the determination related to the region of the target S, the determination unit 115 may perform determination related to the attribute of the target S.

For example, the determination unit 115 can perform determination related to the region of the target S on the basis of the image data.

For example, the determination unit 115 can extract a high signal region and a low signal region in the target S by the determination. The high signal region is a region where the signal intensity is a predetermined value or more within the region imaged by the first imaging element 111. The low signal region is a region where the signal intensity is less than the predetermined value within the region imaged by the first imaging element 111. The predetermined value may be set in advance. For example, the region of interest is labeled with a fluorescent body and thus has a higher signal intensity than another region.

Furthermore, the determination unit 115 may divide the region imaged by the first imaging element 111 into three or more regions according to the value of the signal intensity, not into the above two regions. Signal intensity numerical ranges different from each other may be assigned in advance to each of the three or more regions.

The determination unit 115 preferably determines the feature related to the target S using the learned model. For example, the learned model may be generated by using one or a plurality of combinations of image data of a target including a living tissue and a feature related to the target as training data. Regarding the learned model, the description in “(2-1-1) Determination performed by the first imaging element” described above also applies to the present example.

In step S103, the first imaging element 111 transmits the determination result by the determination unit 115 to the control unit 130.

In a control process of step S104, the control unit 130 receives the determination result transmitted from the first imaging element 111. On the basis of the determination result, the control unit 130 can generate imaging control data for controlling imaging by the second imaging unit 120, image processing control data for controlling processing of image data obtained by imaging by the second imaging unit 120, or both of these data.

For example, the control unit 130 can generate, as the imaging control data, imaging control data related to a way of division imaging by the second imaging element 121. The imaging control data can include, for example, data related to a way of setting the imaging region, a way of division, an order of imaging the divided regions, imaging conditions (for example, magnification, gain, exposure time, light amount, and the like), or the like.

The imaging control data generated by the control unit 130 can include, for example, an imaging condition of the high signal region and an imaging condition of the low signal region. For example, the imaging condition can be set such that the exposure time in the imaging of the high signal region is shorter than the exposure time in the imaging of the low signal region. It is possible to prevent blown-out highlights or blocked up shadows by performing imaging with the second imaging element 121 according to this imaging condition.

Furthermore, for example, in a case where fluorescence of a plurality of wavelengths is detected, for example, in a case where the signal intensity varies depending on the wavelength, the control unit 130 can set different exposure times for the wavelengths.

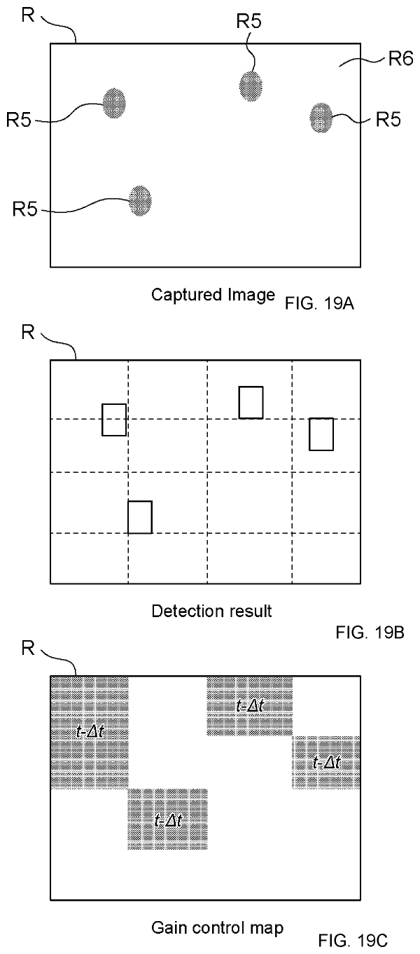

For example, as illustrated in a of FIG. 19, it is assumed that a plurality of regions of interest R5 and another region R6 exist in the region R imaged by the first imaging element 111. The regions of interest R5 are, for example, regions where cells labeled with a fluorescent body exist, and are brighter than the another region R6. The image data in a of FIG. 19 is determined by the determination unit 115, so that the determination unit 115 extracts the region of interest R5 and divides the region R as indicated by the broken lines as illustrated in b of FIG. 19. As illustrated in c of FIG. 19, the control unit 130 sets the exposure time for each divided region. Specifically, the control unit 130 sets exposure time t−Δt for the divided regions including the regions of interest R5, and sets exposure time t for the another divided region. That is, the exposure time of the divided regions including the regions of interest is shorter than the exposure time of the another divided region. In this manner, the control unit 130 can generate the imaging control data including the way of division and the exposure time assigned to each divided region.

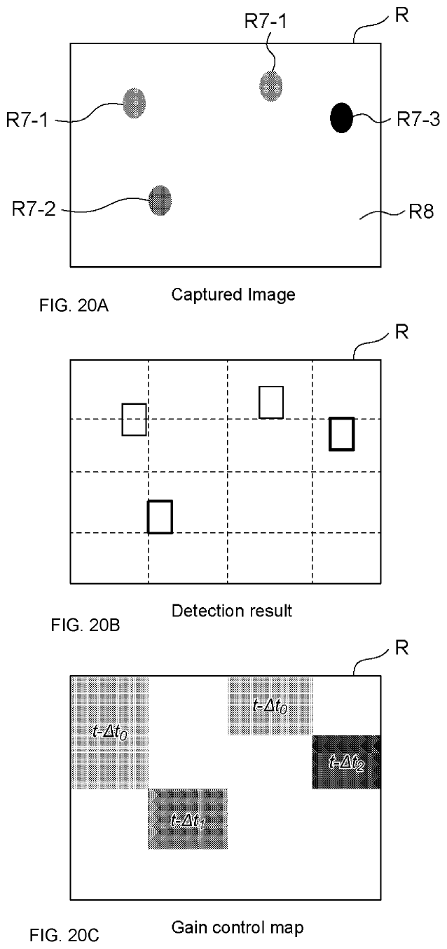

In FIG. 19, the region R includes two types of regions R5 and R6, but may include three or more types of regions. For example, three or more types of exposure times may be set for the exposure time according to the signal intensity of the region of interest. An example in which three or more types of exposure times are set will be described with reference to FIG. 20.

For example, as illustrated in a of FIG. 20, it is assumed that a plurality of regions of interest R7-1, R7-2, and R7-3 and another region R8 exist in the region R imaged by the first imaging element 111. The signal intensities of the regions of interest R7-1, R7-2, and R7-3 are different from each other. The regions of interest R7-1, R7-2, and R7-3 are, for example, regions where cells labeled with different fluorescent bodies exist, and are brighter than the another region R8. The image data in a of FIG. 20 is determined by the determination unit 115, so that the determination unit 115 extracts the regions of interest R7-1, R7-2, and R7-3 and divides the region R as indicated by the broken lines as illustrated in b of FIG. 20. As illustrated in c of FIG. 20, the control unit 130 sets the exposure time for each divided region. Specifically, the control unit 130 sets respective exposure times t-Δt₀, t-Δt₁, and t-Δt₂ for the divided regions of the regions of interest R7-1, R7-2, and R7-3, and sets exposure time t for the another divided region. That is, the exposure times of the divided regions including the regions of interest are shorter than the exposure time of the another divided region, and the exposure times are set according to the signal intensities of the regions of interest. For example, for example, a shorter exposure time can be set for a divided region including a region of interest with a higher signal intensity, and a longer exposure time can be set for a divided region including a region of interest with a lower signal intensity.

The control unit 130 may generate the imaging control data including the way of division and the exposure time assigned to each divided region as described above.

As described above, the control unit 130 can divide the region imaged by the first imaging element 111 into the region of interest and another region, and then, the control unit 130 can generate imaging control data for controlling the second imaging element 121 such that the region of interest is imaged with a shorter exposure time than the another region.

In step S104, the control unit 130 transmits the generated imaging control data to the second imaging unit 120 (for example, the second imaging element 121 or the like).

In the second imaging process of step S105, the second imaging unit 120 receives the imaging control data generated in step S104, and images the target S on the basis of the imaging control data. Prior to the imaging, the control unit 130 moves the stage 140 on which the target S is placed to a position where imaging can be performed by the second imaging unit 120.

For example, in step S105, the second illumination optical system 123 irradiates the target S on the stage 140 with excitation light of the fluorescent body included in the target S. The excitation light can be the same as the light emitted in step S102. In step S105, the control unit 130 or the user can control the second illumination optical system 123 to emit the excitation light.

In step S105, the second imaging element 121 can image the target S, for example, at a magnification different from that of the first imaging element 111 on the basis of the imaging control data in a state where the target S is irradiated with the light. For example, the second imaging element 121 can divide the region imaged by the first imaging element 111 into a plurality of regions and image the divided regions on the basis of the imaging control data. For example, the second imaging element 121 may perform imaging a plurality of times, thereby obtaining a plurality of pieces of image data.

For example, regarding the example illustrated in FIG. 19, the second imaging element 121 can image the region of interest R5 with the exposure time t−Δt and can image the another region R6 with the exposure time t.

In step S105, the second imaging element 121 receives the fluorescence generated from the target S by the excitation light irradiation through the second observation optical system 122. The second observation optical system 122 can include a wavelength separation element (for example, a filter or a spectroscope) in order to separate and receive desired fluorescence.

The second imaging element 121 transmits image data (one or a plurality of pieces of divided image data, in particular, a plurality of pieces of divided image data) acquired by imaging in step S105 to the control unit 130.

In an image processing process of step S106, the control unit 130 receives the image data (one or a plurality of pieces of divided image data, in particular, a plurality of pieces of divided image data) acquired in step S105, and performs the image processing using the image data.

For example, in step S106, the control unit 130 can generate one piece of image data by using two or more pieces of image data of the plurality of pieces of image data. For example, the control unit 130 can generate image data of the entire region imaged in step S102 using the plurality of pieces of image data.

The image data generated by the image processing in step S106 may be stored in, for example, a storage medium provided in the microscope device 100, or may be stored in an external storage medium connected to the microscope device 100 by wire or wirelessly.

In step S107, the microscope device 100 ends the imaging processing.

(2-8) Fourth Example of Imaging Control (Imaging Control of Target Including Unnecessary Region)

In the case of microscopic observation of a living tissue, for example, artifacts such as a glass defect region, a glass edge portion, dirt, bubbles, an embedding agent, and a marker (for example, printed or handwritten) can exist in the field of view. The artifacts can adversely affect imaging of the region of interest.

Furthermore, in the case of microscopic observation of a living tissue, the living tissue not to be analyzed can exist in the field of view. The living tissue not to be analyzed can also adversely affect imaging of the region of interest. Furthermore, there is a case where a detailed image is not obtained for a living tissue not to be analyzed.

With the microscope device of the present technology, for example, a region of interest can be imaged without imaging an unnecessary region such as an artifact and a living tissue not to be analyzed, or a region of interest can be imaged so that the data amount regarding the unnecessary region is reduced. Therefore, imaging failure can be prevented. Furthermore, the influence of the unnecessary region on the focus can be reduced. Hereinafter, an example of such imaging processing will be described.

(2-8-1) Imaging Control of Target Including Artifact

An example of imaging processing in which an artifact is extracted as an unnecessary region by the microscope device of the present technology and an imaging sequence of the microscope device is controlled on the basis of a result of the extraction will be described with reference to FIGS. 1A, 1B and 15.

Steps S101 and S102 in FIG. 15 are as described above in “(2-5) First example of imaging control (fluorescence separation processing)”, and the description is also applied to the present example.

In the determination process of step S103, the first imaging element 111 (in particular, the determination unit 115) determines a feature related to the target S on the basis of the image data acquired in step S102.

In step S103, for example, the determination unit 115 can perform determination related to the region of the target S on the basis of the image data. For example, the determination unit 115 can extract the unnecessary region in the target S by the determination. The unnecessary region can be, for example, an artifact region or a living tissue region not to be analyzed.

For example, in step S103, the determination unit 115 can extract a living tissue region and an object region (for example, a label on a slide, a cover glass, a glass slide, or the like) other than a living tissue in the image data.

In step S103, the determination unit 115 can further extract an artifact in the image data. The artifact can be, for example, a glass defect, dirt, bubbles, an embedding agent, or magic marker (printing with a marker). The artifact may exist, for example, within the living tissue region or may exist outside the living tissue region.

Furthermore, in step S103, in addition to the determination related to the region of the target S, the determination unit 115 may perform determination related to the attribute of the target S. For example, determination regarding the attribute of a living tissue can be performed.

The determination unit 115 preferably determines the feature related to the target S using the learned model. For example, the learned model may be generated by using one or a plurality of combinations of image data of a target including a living tissue and a feature related to the target as training data. Regarding the learned model, the description in “(2-1-1) Determination performed by the first imaging element” described above also applies to the present example.

In step S103, the first imaging element 111 transmits the determination result by the determination unit 115 to the control unit 130.

In a control process of step S104, the control unit 130 receives the determination result transmitted from the first imaging element 111. On the basis of the determination result, the control unit 130 can generate imaging control data for controlling imaging by the second imaging unit 120, image processing control data for controlling processing of image data obtained by imaging by the second imaging unit 120, or both of these data.

For example, the control unit 130 can generate, as the imaging control data, imaging control data related to a way of division imaging by the second imaging element 121. The imaging control data can include, for example, data related to a way of setting the imaging region, a way of division, an order of imaging the divided regions, imaging conditions (for example, magnification, gain, exposure time, light amount, and the like), or the like.

The imaging control data generated by the control unit 130 can include, for example, data related to the way of division. According to the data related to the way of division, the region of the image data acquired in step S102 is divided into a plurality of divided regions.

The imaging control data generated by the control unit 130 can include, for example, an imaging condition for a divided region including an unnecessary region and an imaging condition for a divided region not including an unnecessary region. For example, these imaging conditions for the divided regions can be set such that the resolution or magnification in the imaging of the divided region including the unnecessary region is lower than the resolution or magnification in the imaging of the divided region not including the unnecessary region.

Furthermore, the control unit 130 may set an imaging condition of not imaging the divided region including the unnecessary region.

Furthermore, for example, there is a case where the region of interest in a pathological specimen and the artifact overlap. In such a case, the control unit 130 extracts the artifact as an unnecessary region, but the unnecessary region is included in the region of interest. In a case where the region of interest includes the unnecessary region as described above, the divided region including the unnecessary region may be set as an imaging target in the second imaging process (in particular, an imaging target of high resolution or high magnification).

In this case, preferably, the control unit 130 can set the imaging sequence such that the divided region including the unnecessary region is imaged after the peripheral divided region not including the unnecessary region. There is a possibility that autofocus fails for the divided region including the unnecessary region due to the presence of the artifact. By setting the imaging sequence as described above, it is possible to use the result of autofocus of the peripheral divided region not including the unnecessary region, and thus, it is possible to avoid failure of autofocus.

As described above, the control unit 130 can divide the region imaged by the first imaging element 111 into the divided region including the unnecessary region and the divided region not including the unnecessary region, and can set the imaging condition for each divided region. Then, the control unit 130 can generate the imaging control data for controlling the second imaging element 121 such that the divided region not including the unnecessary region is imaged with higher image quality than the divided region including the unnecessary region.

In step S104, the control unit 130 transmits the generated imaging control data to the second imaging unit 120 (for example, the second imaging element 121 or the like).

In the second imaging process of step S105, the second imaging unit 120 receives the imaging control data generated in step S104, and images the target S on the basis of the imaging control data. Prior to the imaging, the control unit 130 moves the stage 140 on which the target S is placed to a position where imaging can be performed by the second imaging unit 120.

For example, in step S105, the second illumination optical system 123 irradiates the target S on the stage 140 with excitation light of the fluorescent body included in the target S. The excitation light may be the same as or different from the light emitted in step S102. In step S105, the control unit 130 or the user can control the second illumination optical system 123 to emit the excitation light.

In step S105, the second imaging element 121 can image the target S, for example, at a magnification different from that of the first imaging element 111 on the basis of the imaging control data in a state where the target S is irradiated with the light. For example, the second imaging element 121 can divide the region imaged by the first imaging element 111 into a plurality of divided regions and image the divided regions on the basis of the imaging control data.

In step S105, the second imaging element 121 receives the fluorescence generated from the target S by the excitation light irradiation through the second observation optical system 122. The second observation optical system 122 can include a wavelength separation element (for example, a filter or a spectroscope) in order to separate and receive desired fluorescence.

The second imaging element 121 transmits image data (one or a plurality of pieces of divided image data, in particular, a plurality of pieces of divided image data) acquired by imaging in step S105 to the control unit 130.

In an image processing process of step S106, the control unit 130 receives the image data (one or a plurality of pieces of divided image data, in particular, a plurality of pieces of divided image data) acquired in step S105, and performs the image processing using the image data.

For example, in step S106, the control unit 130 can generate one piece of image data by using two or more pieces of image data of the plurality of pieces of image data. For example, the control unit 130 can generate image data of the entire region imaged in step S102 using the plurality of pieces of image data.

The image data generated by the image processing in step S106 may be stored in, for example, a storage medium provided in the microscope device 100, or may be stored in an external storage medium connected to the microscope device 100 by wire or wirelessly.

In step S107, the microscope device 100 ends the imaging processing.

(2-8-2) Imaging Control of Target Including Living Tissue not to be Analyzed

An example of imaging processing in which a living tissue region not to be analyzed is extracted as an unnecessary region by the microscope device of the present technology and an imaging sequence or image processing of the microscope device is controlled on the basis of a result of the extraction will be described with reference to FIGS. 1A, 1B and 15.

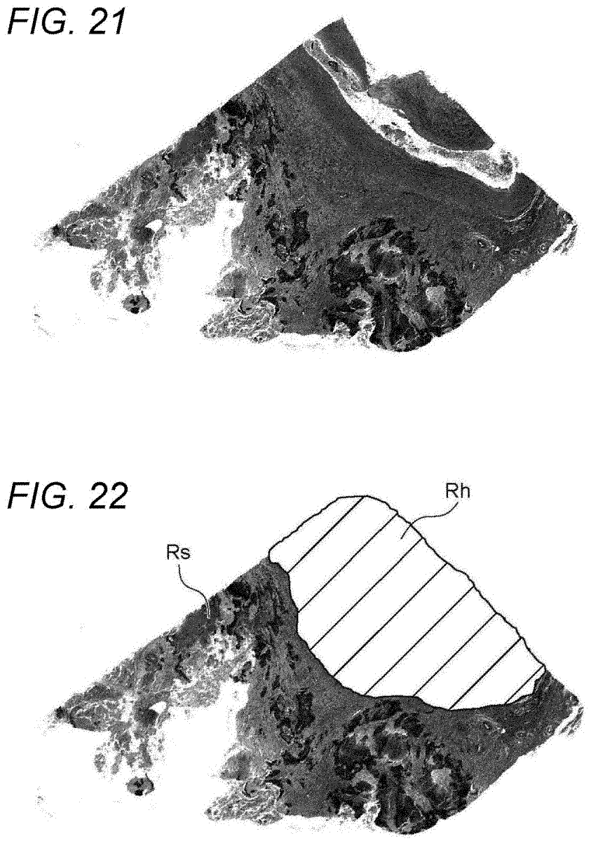

Steps S101 and S102 in FIG. 15 are as described above in “(2-5) First example of imaging control (fluorescence separation processing)”, and the description is also applied to the present example. In the present example, it is assumed that the image data illustrated in FIG. 21 is acquired. Within the living tissue in the image data, a hatched region Rh illustrated in FIG. 22 is assumed to be a living tissue not to be analyzed.

In the determination process of step S103, the first imaging element 111 (in particular, the determination unit 115) determines a feature related to the target S on the basis of the image data acquired in step S102.

In step S103, for example, the determination unit 115 can perform determination related to the region of the target S on the basis of the image data. For example, according to the determination, the determination unit 115 determines that the hatched region Rh illustrated in FIG. 22 is a region not to be analyzed. Another living tissue region Rs is determined to be an analysis target region.

The determination unit 115 preferably determines the feature related to the target S using the learned model. For example, the learned model may be generated by using one or a plurality of combinations of image data of a target including a living tissue and a feature related to the target as training data. Regarding the learned model, the description in “(2-1-1) Determination performed by the first imaging element” described above also applies to the present example.

In step S103, the first imaging element 111 transmits the determination result by the determination unit 115 to the control unit 130.

In a control process of step S104, the control unit 130 receives the determination result transmitted from the first imaging element 111. On the basis of the determination result, the control unit 130 can generate imaging control data for controlling imaging by the second imaging unit 120, image processing control data for controlling processing of image data obtained by imaging by the second imaging unit 120, or both of these data.

For example, the control unit 130 can generate, as the imaging control data, imaging control data related to a way of division imaging by the second imaging element 121.

The imaging control data generated by the control unit 130 includes, for example, imaging control data in which the second imaging element 121 does not image the hatched region Rg, but the second imaging element 121 images the another living tissue region Rs.

In step S104, the control unit 130 transmits the generated imaging control data to the second imaging unit 120 (for example, the second imaging element 121 or the like).

In the second imaging process of step S105, the second imaging unit 120 receives the imaging control data generated in step S104, and images the target S on the basis of the imaging control data. Prior to the imaging, the control unit 130 moves the stage 140 on which the target S is placed to a position where imaging can be performed by the second imaging unit 120.

For example, in step S105, the second illumination optical system 123 irradiates the target S on the stage 140 with excitation light of the fluorescent body included in the target S. The excitation light may be the same as or different from the light emitted in step S102. In step S105, the control unit 130 or the user can control the second illumination optical system 123 to emit the excitation light.

In step S105, the second imaging element 121 can image the target S, for example, at a magnification different from that of the first imaging element 111 on the basis of the imaging control data in a state where the target S is irradiated with the light. For example, the second imaging element 121 can image the another living tissue region within the region imaged by the first imaging element 111 on the basis of the imaging control data.

The second imaging element 121 transmits image data of the another living tissue region acquired by imaging in step S105 to the control unit 130.

In the image processing process of step S106, the control unit 130 receives the image data acquired in step S105, and performs the image processing using the image data. For example, the fluorescence separation processing can be performed on the image data.

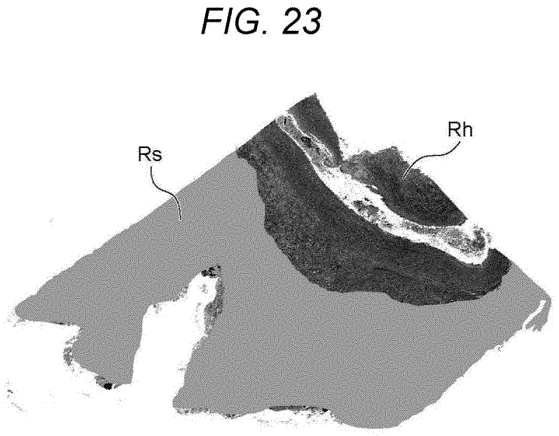

Furthermore, in step S106, image synthesis processing by the control unit 130 may be performed. For example, the control unit 130 can synthesize the image of the hatched region Rh (region not to be analyzed) within the image data acquired in step S102 and the image of the another living tissue region Rs (analysis target region) acquired in step S105 to generate a synthetic image of the two images captured under different imaging conditions, for example, as illustrated in FIG. 23.

As described above, the control unit of the microscope device of the present technology can synthesize two or more partial images captured under different imaging conditions to generate a synthetic image.

The image data generated by the image processing in step S106 may be stored in, for example, a storage medium provided in the microscope device 100, or may be stored in an external storage medium connected to the microscope device 100 by wire or wirelessly.

In step S107, the microscope device 100 ends the imaging processing.

(3) Second Example of the First Embodiment

The present technology also provides a microscope device including: a first imaging element that images a target including a living tissue and acquires image data; a second imaging element that images the target at a magnification different from a magnification of the first imaging element and acquires image data; and a determination unit 115 that determines a feature related to the target using a learned model on the basis of the image data, in which the second imaging element is controlled on the basis of a result of the determination. In the microscope device, the second imaging element is controlled on the basis of the determination result by the determination unit 115 using the learned model. Therefore, it is possible to efficiently or appropriately acquire an image of a specific region (for example, a region of interest) in a living tissue.

The microscope device of the second example is the same as the microscope device of the first example described above except that it is essential that determination by the determination unit 115 is performed using a learned model and the determination unit 115 may not be included in the first imaging element.

The determination using the learned model may be performed as described in the first example described above. The determination enables efficient or appropriate image acquisition.

For example, the determination unit 115 may be provided outside the first imaging element 111. In one embodiment, the determination unit 115 may be provided inside the microscope device 100 and outside the first imaging element 111, and may be included, for example, in the control unit 130.

### 2. Second Embodiment (Image Acquisition System)

The present technology also provides an image acquisition system including: the microscope device described in 1. described above, and a control unit that performs imaging control of the target by the second imaging element or control of processing of an image obtained by the second imaging element, on the basis of a result of determination by the determination unit 115 included in the microscope device.

In this embodiment, the control unit may be provided in the microscope device or may be provided outside the microscope device. For example, the control unit may be configured as an information processing device connected to the microscope device by wire or wirelessly, or the control unit may be configured as a server connected to the microscope device via a network.

### 3. Second Embodiment (Image Acquisition Method)

An image acquisition method according to the present technology includes: a first imaging process of imaging a target including a living tissue and acquiring image data by a first imaging element; a determination process of determining a feature related to the target based on the image data, performed by a determination unit included in the first imaging element; and a second imaging process of imaging the target at a magnification different from a magnification of the first imaging element and acquiring image data, in which the second imaging element is controlled on the basis of a result of the determination.

The first imaging process is the first imaging process in step S102 in FIG. 15, and the content regarding step S102 described in 1. described above applies to the present embodiment.

The determination process is the determination process in step S103 in FIG. 15, and the content regarding step S103 described in 1. described above applies to the present embodiment.

The second imaging process is the second imaging process in step S105 in FIG. 15, and the content regarding step S105 described in 1. described above applies to the present embodiment.

Furthermore, the image acquisition method can include other processes (control process S104, image processing process S106) in FIG. 15 described in 1. described above.

Furthermore, the image acquisition method may be performed using, for example, the microscope device 100 described in 1. described above, but may be performed by another microscope device.

Note that the present technology may adopt the configuration described below.

[1]

A microscope device including:

a first imaging element that images a target including a living tissue and acquires image data; and

a second imaging element that images the target at a magnification different from a magnification of the first imaging element and acquires image data, in which

the first imaging element includes a determination unit that determines a feature related to the target on the basis of the image data, and

the second imaging element is controlled on the basis of a result of the determination.

[2]

The microscope device according to [1], in which the second imaging element further divides the imaged region into a plurality of regions, images at least one of the plurality of regions, and acquires image data.

[3]

The microscope device according to [1] or [2], in which the first imaging element is an imaging element in which the determination unit and an imaging section that performs imaging are arranged in a single chip.

[4]

The microscope device according to any one of [1] to [3], in which the second imaging element images each of the plurality of regions at a higher magnification than the first imaging element.

[5]

The microscope device according to any one of [1] to [4], in which the image data is bright-field image data and/or fluorescence image data.

[6]

The microscope device according to any one of [1] to [5], in which the image data is an image signal including a luminance value and/or a frequency.

[7]

The microscope device according to any one of [1] to [6], in which the feature related to the target includes a feature related to an attribute of the target.

[8]

The microscope device according to [7], in which the feature related to the attribute of the target includes one or more selected from a feature related to an attribute of the living tissue, a feature related to an autofluorescence component, and a feature related to a lesion in the living tissue.

[9]

The microscope device according to any one of [1] to [6], in which the feature related to the target includes a feature related to a region of the target.

[10]

The microscope device according to [9], in which the feature related to the region of the target includes one or more selected from a feature related to a lesion region in the living tissue and a feature related to a foreign substance in the target.

[11]

The microscope device according to any one of [1] to [10], in which the determination unit performs the determination using a learned model.

[12]

The microscope device according to any one of [1] to [11], further including: a control unit that performs imaging control of the target by the second imaging element or control of processing of an image obtained by the second imaging element, on the basis of a result of determination by the determination unit.

[13]

The microscope device according to [12], in which the control unit further includes an imaging sequence control unit that controls an imaging order on the basis of a feature related to a region of the target.

[14]

The microscope device according to [13], in which

the imaging sequence control unit

performs imaging control such that a joint of a plurality of regions does not overlap a region of interest in the target, or

the imaging sequence control unit performs imaging control such that the region of interest in the target is imaged a plurality of times.

[15]

The microscope device according to any one of [12] to [14], in which the control unit further includes an exposure control unit that controls a gain and/or an exposure time.

[16]

The microscope device according to [15], in which the exposure control unit controls the gain and/or the exposure time in units of pixels and/or in units of wavelengths.

[17]

The microscope device according to any one of [12] to [16], in which the control unit further includes a light amount control unit that controls a light amount of a light source.

[18]

The microscope device according to any one of [12] to [17], in which processing of the image includes fluorescence separation processing.

[19]

An image acquisition system including:

a microscope device including a first imaging element that images a target including a living tissue and acquires image data, and a second imaging element that divides the imaged region into a plurality of regions and images the regions, the first imaging element further including a determination unit that determines a feature related to the target on the basis of the image data, the second imaging element being controlled on the basis of a result of the determination; and

a control unit that performs imaging control of the target by the second imaging element or control of processing of an image obtained by the second imaging element on the basis of a result of the determination.

An image acquisition method including:

a first imaging process of imaging a target including a living tissue and acquiring image data by a first imaging element;

a determination process of determining a feature related to the target based on the image data, performed by a determination unit included in the first imaging element; and

a second imaging process of dividing the imaged region into a plurality of regions and imaging the regions by the second imaging element, in which

the second imaging element is controlled on the basis of a result of the determination.

### REFERENCE SIGNS LIST

100 Microscope device
110 First imaging unit
111 First imaging element
112 First observation optical system
113 First illumination optical system
120 Second imaging unit
121 Second imaging element
122 Second observation optical system
123 Second illumination optical system
130 Control unit
140 Stage

1. A microscope device comprising:
a first imaging element that images a target including a living tissue and acquires image data; and
a second imaging element that images the target at a magnification different from a magnification of the first imaging element and acquires image data, wherein
the first imaging element includes a determination unit that determines a feature related to the target on a basis of the image data, and
the second imaging element is controlled on a basis of a result of the determination.

2. The microscope device according to claim 1, wherein the second imaging element further divides the imaged region into a plurality of regions, images at least one of the plurality of regions, and acquires image data.

3. The microscope device according to claim 1, wherein the first imaging element is an imaging element in which the determination unit and an imaging section that performs imaging are arranged in a single chip.

4. The microscope device according to claim 1, wherein the second imaging element images each of the plurality of regions at a higher magnification than the first imaging element.

5. The microscope device according to claim 1, wherein the image data is bright-field image data and/or fluorescence image data.

6. The microscope device according to claim 1, wherein the image data is an image signal including a luminance value and/or a frequency.

7. The microscope device according to claim 1, wherein the feature related to the target includes a feature related to an attribute of the target.

8. The microscope device according to claim 7, wherein the feature related to the attribute of the target includes one or more selected from a feature related to an attribute of the living tissue, a feature related to an autofluorescence component, and a feature related to a lesion in the living tissue.

9. The microscope device according to claim 1, wherein the feature related to the target includes a feature related to a region of the target.

10. The microscope device according to claim 9, wherein the feature related to the region of the target includes one or more selected from a feature related to a lesion region in the living tissue and a feature related to a foreign substance in the target.

11. The microscope device according to claim 1, wherein the determination unit performs the determination using a learned model.

12. The microscope device according to claim 1, further comprising: a control unit that performs imaging control of the target by the second imaging element or control of processing of an image obtained by the second imaging element, on a basis of a result of determination by the determination unit.

13. The microscope device according to claim 12, wherein the control unit further includes an imaging sequence control unit that controls an imaging order on a basis of a feature related to a region of the target.

14. The microscope device according to claim 13, wherein
the imaging sequence control unit
performs imaging control such that a joint of a plurality of regions does not overlap a region of interest in the target, or
performs imaging control such that the region of interest in the target is imaged a plurality of times.

15. The microscope device according to claim 12, wherein the control unit further includes an exposure control unit that controls a gain and/or an exposure time.

16. The microscope device according to claim 15, wherein the exposure control unit controls the gain and/or the exposure time in units of pixels and/or in units of wavelengths.

17. The microscope device according to claim 12, wherein the control unit further includes a light amount control unit that controls a light amount of a light source.

18. The microscope device according to claim 12, wherein processing of the image includes fluorescence separation processing.

19. An image acquisition system comprising:
a microscope device including a first imaging element that images a target including a living tissue and acquires image data, and a second imaging element that images the target at a magnification different from a magnification of the first imaging element and acquires image data, the first imaging element further including a determination unit that determines a feature related to the target on a basis of the image data, the second imaging element being controlled on a basis of a result of the determination; and
a control unit that performs imaging control of the target by the second imaging element or control of processing of an image obtained by the second imaging element on a basis of a result of the determination.

20. An image acquisition method comprising:
a first imaging process of imaging a target including a living tissue and acquiring image data by a first imaging element;
a determination process of determining a feature related to the target based on the image data, performed by a determination unit included in the first imaging element; and
a second imaging process of imaging the target at a magnification different from a magnification of the first imaging element and acquiring image data, wherein
the second imaging element is controlled on a basis of a result of the determination.
